(19) United States
(12) Patent Application Publication
(10) Pub. No.: US 2016/0232292 A1
(43) Pub. Date: Aug. 11, 2016

(54) METHODS, SYSTEMS, AND COMPUTER PROGRAM PRODUCTS FOR IMPLEMENTING KNOWLEDGE BASE-DRIVEN GENERATION OF IMMUNOASSAY PROTOCOLS AND PROCEDURES

(71) Applicants: Marc Key, Ojai, CA (US); Bipin Gupta, Pleasanton, CA (US)

(72) Inventors: Marc Key, Ojai, CA (US); Bipin Gupta, Pleasanton, CA (US)

(21) Appl. No.: 15/016,292

(22) Filed: Feb. 5, 2016

Related U.S. Application Data
(60) Provisional application No. 62/112,425, filed on Feb. 5, 2015.

(51) Int. Cl. G06F 19/24; G06F 19/18; C40B 30/02

(52) U.S. Cl. CPC G06F 19/24; C40B 30/02; G06F 19/18

(57) ABSTRACT

Disclosed are techniques for implementing knowledge base-driven generation of immunoassay protocols and procedures. These techniques invoke an expert system or knowledge engineering base to identify or determine one or more proteins of interest for one or more tumor types of interest or a disease group of interest and further invoke a protocol generation module that is stored at least partially in memory and includes or functions in tandem with one or more processors of a computing system to generate a concurrent or a sequential immunoassay protocol based in part or in whole upon one or more immunoassay protocol rules and the one or more tumor types of interest or a disease group of interest. These techniques may further invoke an immunoassay procedure generation module to generate a sequential or concurrent immunoassay procedure based in part or in whole upon one or more immunoassay experimental conditions.

### CROSS-REFERENCE TO RELATED APPLICATION(S)

This application claims the benefit of U.S. provisional patent application Ser. No. 62/112,425, filed Feb. 5, 2015 and entitled “Software Program For Optimization Of Multiplex Immunohistochemistry”. The aforementioned U.S. provisional patent application is herein expressly incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Cancers of unknown origin present a diagnostic challenge. Oftentimes, the list of potential cancers may be narrowed down based on the anatomic location of the tumor. For example tumors originating in the lung may be one of several types of lung cancer. Identification of the specific type of cancer, known as differential diagnosis, is critical for the proper treatment of the patient. Immunoassay is a method to aid in the differential diagnosis. It is a biochemical test that measures the presence or concentration of a molecule in a solution or on a solid phase, through the use of an antibody or immunoglobulin. The molecule detected by the immunoassay in many cases is a protein. For immunoassay to function properly one or more primary antibodies are reacted with the unknown tumor.

Single-stain immunoassays have been used for studying cells and tissues where a single stain is generated that corresponds to a single molecule being investigated. The stained cells or tissues can then be examined, for example with a microscope, to confirm the presence of the single molecule being investigated. Chromogens that are commonly used in immunoassays comprise diaminobenzidine (DAB) that generates a brown end-product; Fast Red that generates a red end-product; and Fast-Blue that generates a blue end-product. There are other chromogens that generate other specific colors. For example, in order to make a diagnosis of lung adenocarcinoma, a pathologist may choose to stain for a molecule called thyroid transcription factor-1 (TTF-1) that is specific for certain types of lung cancer including lung adenocarcinoma.

With the use of DAB as the substrate, the presence of brown stain is indicative of the presence of TTF-1, which is also indicative of lung adenocarcinoma, whereas the lack of a brown stain means that lung adenocarcinoma is not present. However, the presence or absence of brown stain does not rule out the possibility or probability of the presence of other types of lung cancer, such as mesothelioma, in a sample. In this case, the pathologist may likely use another slide, prepared from the same tumor sample, and stain the slide for testing the presence of another molecule that is associated with mesothelioma, such as calretinin. If the latter sample is stained positive (brown) for calretinin, then the tumor may more likely be a mesothlelioma. As it may be seen by this example, positive stain on the first slide (TTF-1) may be indicative of adenocarcinoma, whereas positive stain on the second slide (Calretinin) may be indicative of mesothlioma.

Although the use of a single antibody is a commonly used method, multiplex immunoassay may also be conducted utilizing more than one antibody. In multiplex immunoassay, selecting the most relevant set of primary antibodies depending on the differential diagnosis under investigation may affect the success or failure of the diagnosis. For example an unknown pulmonary tumor may require a different set of antibodies than an unknown tumor of another organ may. A common method of performing multiple immuno-staining is performing a single stain immunoassay on a single slide. In this approach, multiple different slides may be singly stained until all the desired stains have been generated. The selection of the primary antibodies to be applied to the single stains may require extensive expertise, understanding, and experiences of an expert and may further involve guesses or trials and errors in determining the immunoassay protocols and the immunoassay procedures by the user.

Compared to single antibody-immunoassay, multiplex-immunoassay is much more complex and requires adherence to a strict set of rules in order for the diagnosis to be successful. Adherence to these rules requires extensive expertise, understanding, and experiences of one or more experts and may further involve guesses or trials and errors and is thus beyond the skill and knowledge level of most laboratory workers. Moreover, in a case of many possible cancer types for diagnosis, there may exist more than two possibilities. For example, there are generally five different common tumor types that include: 1) adenocarcinoma, 2) mesothelioma, 3) squamous cell carcinoma, 4) small cell carcinoma, and 5) non-small cell carcinoma for lung cancers.

In addition, there may exist other tumors such as lymphoma, or tumors that have metastasized to the lung from other tissue sites that may also be found in the lung. Thus, a double-stain of just two possibilities may be inadequate to provide a complete diagnosis. Designing multiplex immuno-stains to identify more than two different possibilities all on a single microscope slide is often desired or required. Multiplex -immunoassay has been heavily or solely relying upon the expertise and experience of human experts while the guesswork and trial and error elements nevertheless continue to hinder the efficiencies, cost, the time to develop successful or effective protocols and corresponding procedures, as well as costs of such development or diagnosis.

Multiplex immuno-staining may theoretically be performed using multiple chromogens, where each chromogen has its own unique color that is visually distinguishable from all others. From a feasibility or practicality perspective, developing an immunoassay protocol and the required analysis become much more complicated. One of many challenges require thorough understanding of the technical aspects of immunoassay; and each step in an immunoassay procedure needs to be rigorously controlled to ensure specificity of the reaction.

Therefore, there exists a need for methods, systems, and computer program product for implementing knowledge base-driven generation of immunoassay protocols and procedures to address these challenges and shortcomings of conventional approaches.

### SUMMARY

Disclosed are methods, systems, and computer program products for implementing knowledge base-driven generation of immunoassay protocols and procedures in various embodiments. Some first embodiments are directed at a method for implementing knowledge base-driven generation of immunoassay protocols and procedures. In these embodiments, one or more proteins of interest for one or more tumor types of interest or a disease group of interest may be identified or determined by at least an expert system or knowledge engineering base. an immunoassay protocol may be generated by a protocol generation module that is stored at least partially in memory and includes or functions in tandem with one or more processors of a computing system based in part or in whole upon one or more immunoassay protocol rules and the one or more tumor types of interest or a disease group of interest.

In some of these embodiments, an immunoassay procedure may be generated at an immunoassay procedure generation module stored at least partially in the memory and including or functioning in tandem with the one or more processors of the computing system based in part or in whole upon one or more immunoassay experimental conditions. In addition or in the alternative, one or more modules including the expert system or knowledge base or the protocol generation module may be calibrated or trained at least by using results of detecting or measuring one or more proteins of interest for the one or more tumor types of interest or the disease group of interest as a test data set.

In some embodiments, one or more proteins of interest may be identified or determined based in part or in whole upon the disease group of interest or the one or more tumor types of interest for a sample; one or more primary antibodies may be determined based in part or in whole upon the one or more proteins of interest using one or more primary antibody rules; and one or more relative strength indices corresponding to the one or more primary antibodies may be identified or determined at the expert system or the knowledge engineering base.

In some of these immediately preceding embodiments, a number of different species may be identified in the one or more primary antibodies; a first species and a second species of the one or more primary antibodies may be identified or determined; and one or more rule modules may determine whether the first species and the second species are identical. In some embodiments, a set of concurrent multiplex rules may be activated for one or more rule modules based in part or in whole upon a results of determining whether the first species and the second species are identical; two or more primary antibodies comprising a first primary antibody and a second primary antibody may be identified based in part or in whole upon one or more primary antibody rules and the set of concurrent multiplex rules; and one or more enzymes or fluorescent probes that bind to the first primary antibody and the second primary antibody may be determined based in part or in whole upon one or more enzyme or fluorescent rules and the set of concurrent multiplex rules.

In some of these immediately preceding embodiments, a first secondary antibody and a second secondary antibody may be determined based in part or in whole upon the first primary antibody, the second primary antibody, one or more secondary antibody rules, and the set of concurrent multiplex rules; and a first substrate or chromogen and a second substrate or chromogen may be determined based in part or in whole upon the first and second primary antibodies or the first and second secondary antibodies, one or more substrate or chromogen rules, and the set of concurrent multiplex rules. In addition or in the alternative, the protocol generation module may generate a concurrent multiplex immunoassay protocol for the immunoassay protocol by including information about at least the first primary antibody, the second primary antibody, and the one or more enzymes or fluorescent probes into the concurrent multiplex immunoassay protocol.

In some embodiments, a number of different species may be identified in the one or more primary antibodies; a species of the one or more primary antibodies may be identified or determined; and one or more modules, either alone or combined with one or more other modules, may determine an enzyme or a fluorescent probe based in part or in whole upon the species and one or more enzyme or fluorescent probe rules.

In some embodiments, one or more rule modules may, either alone or combined with one or more other modules, determine a secondary antibody that is used to bind to the one or more primary antibodies based in part or in whole upon one or more secondary antibody rules; and the one or more rule modules may further determine a substrate or a chromogen based in part or in whole upon detection of binding between the one or more primary antibodies and a protein of interest and one or more substrate or chromogen rules.

In addition or in the alternative, the immunoassay protocol may be generated at least by adding at least the one or more primary antibodies, the enzyme or the fluorescent probe into the immunoassay protocol. In some of these immediately preceding embodiments, the protocol generation module may update the immunoassay protocol at least by adding the secondary antibody or the substrate into the immunoassay protocol. In addition to or in the alternative of a concurrent multiplex immunoassay protocol and a concurrent multiplex immunoassay procedure, a set of sequential multiplex rules may be activated for one or more rule modules; and the protocol generation module may generate a sequential multiplex immunoassay protocol for the immunoassay protocol; and an immunoassay procedure generation module that is stored at least partially in the memory and includes or functions in tandem with the one or more processors of the computing system may generate a sequential immunoassay procedure based in part or in whole upon one or more sequential immunoassay experimental conditions.

Some embodiments are directed at a hardware system that may be invoked to perform any of the methods, processes, or sub-processes disclosed herein. The hardware system may include at least one processor or at least one processor core, which executes one or more threads of execution to perform any of the methods, processes, or sub-processes disclosed herein in some embodiments. The hardware system may further include one or more forms of non-transitory machine-readable storage media or devices to temporarily or persistently store various types of data or information. Some exemplary modules or components of the hardware system may be found in the System Architecture Overview section below.

Some embodiments are directed at an article of manufacture that includes a non-transitory machine-accessible storage medium having stored thereupon a sequence of instructions which, when executed by at least one micro-processor or at least one processor core, causes the at least one micro-processor or the at least one processor core to perform any of the methods, processes, or sub-processes disclosed herein. Some illustrative forms of the non-transitory machine-readable storage media may also be found in the System Architecture Overview section below.

More details of various aspects of the methods, systems, or articles of manufacture for implementing knowledge base-driven generation of immunoassay protocols and procedures are described below with reference to FIGS. 1-6.

### BRIEF DESCRIPTION OF THE DRAWINGS

The drawings illustrate the design and utility of various embodiments of the invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a high level schematic block diagram for implementing knowledge base-driven generation of immunoassay protocols and procedures in one or more embodiments.

FIG. 2 illustrates a high level block diagram for implementing knowledge base-driven generation of immunoassay protocols and procedures in one or more embodiments.

FIG. 3A illustrates a more detailed block diagram for implementing knowledge base-driven generation of immunoassay protocols and procedures in one or more embodiments.

FIG. 3B illustrates a more detailed block diagram for a portion of the block diagram illustrated in FIG. 3A for implementing knowledge base-driven generation of immunoassay protocols and procedures in one or more embodiments.

FIG. 3C illustrates a more detailed block diagram for a portion of the block diagram illustrated in FIG. 3A for implementing knowledge base-driven generation of immunoassay protocols and procedures in one or more embodiments.

FIGS. 3D-E jointly illustrate a more detailed block diagram for a portion of the block diagram illustrated in FIG. 3C for implementing knowledge base-driven generation of immunoassay protocols and procedures in one or more embodiments.

FIG. 3F illustrates a more detailed block diagram for a portion of the block diagram illustrated in FIG. 3C for implementing knowledge base-driven generation of immunoassay protocols and procedures in one or more embodiments.

FIG. 4A illustrates a high level block diagram for implementing knowledge base-driven generation of immunoassay protocols and procedures in one or more embodiments.

FIG. 4B illustrates a more detailed block diagram for a portion of the block diagram illustrated in FIG. 4A for implementing knowledge base-driven generation of immunoassay protocols and procedures in one or more embodiments.

FIGS. 5A-B jointly illustrate a more detailed block diagram for a portion of the block diagram illustrated in FIG. 4A for implementing knowledge base-driven generation of immunoassay protocols and procedures in one or more embodiments.

FIG. 6 illustrates a computerized system on which a method for implementing knowledge base-driven generation of immunoassay protocols and procedures may be implemented.

### DETAILED DESCRIPTION

Various embodiments are directed to a method, system, and computer program product for implementing knowledge base-driven generation of immunoassay protocols and procedures. Other objects, features, and advantages of the invention are described in the detailed description, figures, and claims.

In various embodiments, a knowledge base or expert system including or functioning in tandem with one or more computer processors of one or more computing system as well as a rule deck including one or more sets of rules governing multiplex immuno-staining may be used for implementing knowledge base-driven generation of immunoassay protocols and procedures. These one or more sets of rules may be applied to identify primary antibodies, identify secondary antibodies, identify one or more enzymes, identify substrates or chromogens, and determine or identify an order in which these reagents may be used in an immunoassay protocol or immunoassay procedure.

Violation of one or more of these rules may result in improper staining that may further result in a false positive or a false negative staining and hence a false diagnosis in some embodiments. This level of technical understanding exceeds the abilities of most clinical and even research laboratories. In some embodiments, various immunoassay protocols and immunoassay procedures may be generated with minimal or even no human intervention beyond the identification of one or more tumor types of interest or a disease group of interest at which these immunoassay protocols and immunoassay procedures are targeted to detect.

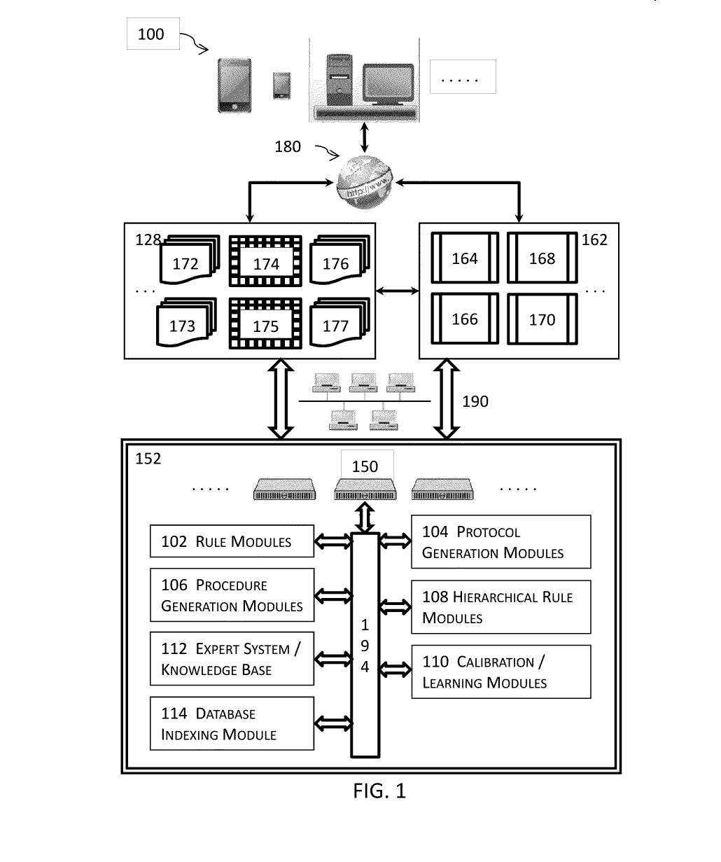

Various embodiments of the methods, systems, and articles of manufacture will now be described in detail with reference to the drawings, which are provided as illustrative examples of the invention so as to enable those skilled in the art to practice the invention. Notably, the figures and the examples below are not meant to limit the scope of various embodiments, unless otherwise specifically described in particular embodiment(s) or recited in the claim(s).

Where certain elements of embodiments may be partially or fully implemented using known components (or methods or processes), portions of such known components (or methods or processes) that are necessary for an understanding of the present invention will be described, and the detailed descriptions of other portions of such known components (or methods or processes) will be omitted for ease of explanation and to not obscure embodiments of the invention. Further, embodiments encompass present and future known equivalents to the components referred to herein by way of illustration. More details about various processes or modules to implement various embodiments are further described below with reference to FIGS. 1-5.

FIG. 1 illustrates a high level schematic block diagrams for implementing knowledge base-driven generation of immunoassay protocols and procedures in one or more embodiments. More specifically, FIG. 1 illustrates an illustrative high level schematic block diagram for implementing knowledge base-driven generation of immunoassay protocols and procedures and may comprise one or more computing systems 100, such as a general purpose computer described in the System Architecture Overview section to implement one or more special proposes.

In some embodiments, the one or more computing systems 100 may invoke various system resources such as the processor(s) or processor core(s), memory, disks, etc. The one or more computing systems 100 may also initiate or interact with other computing systems to access, via a computer bus architecture (e.g., a system bus, a control bus, a data bus, or any combinations thereof), various resources 128 that may comprise static linking libraries and one or more dynamic linking libraries 172 referenced by various modules described herein and the operating system of a computing system (e.g., 102), one or more models 173 (e.g., a decision model, a statistical model, etc.) that use one or more assumptions or one or more hypotheses to correlate various pieces of data.

For example, the one or more models may correlate various antibodies, chromogens, or substrates with various relative strength indices by using one or more assumptions or one or more hypotheses to respectively arrange these antibodies, chromogens, and substrates according to their respective relative strength indices.

These one or more assumptions, one or more hypothesis, and/or one or more models may be further subject to calibration or machine learning (e.g., via the calibration or machine learning module 110) with datasets that have not been used in generating these one or more models. For example, a result dataset generated by using an immunoassay procedure generated by the procedure generation modules 106 may be further used to example calibrate, for example, an assumption or hypothesis regarding relative strength indices of multiple antibodies. It shall be noted that an assumption includes a property, characteristic, or value (e.g., the numeric or symbolic value of a relative strength index) that is predetermined to various modules described herein but has not been validated.

An assumption referred to herein thus may or may not include an assumed, estimated, or guessed value, property, or characteristic. The set of resources 128 may further include one or more data structures 175 (e.g., a relational database for immunoassay protocols, a relational database for immunoassay procedures, etc.) for managing and manipulating (e.g., accessing, editing, querying, etc.) various pieces of information or data (e.g., a rule deck comprising one or more sets of rules) referenced or generated by various modules described herein. The set of resources may also include one or more pieces of data, computer files, or electronic documents 176 for storing inputs (e.g., immunoassay protocol templates, immunoassay procedure templates, etc.) for various modules described herein, and one or more pieces of data or information, computer files, or electronic documents 177 for storing various outputs.

The set of resources 128 may be communicably coupled with a set of standard modules 162 that perform standard computer functions. The set of standard modules 162 may include, for example, a communication module 164 that may be invoked by various modules described herein to issue inter-process function calls, to exchange instructions, data, or messages, etc. The set of standard modules 162 may further include a user interface 166 to interact with a user, an input module 168 to receive various inputs from users or from modules described herein, and an output module 170 to generate various outputs (e.g., immunoassay protocols, immunoassay procedures, etc.) in various different formats.

The one or more computing systems 100 may further write to and read from a local or remote non-transitory computer accessible storage that stores thereupon data or information such as, but not limited to, one or more databases, various statistics, various data, one or more rule decks or sets of rules, etc. that may be used to facilitate the performance of various functions to achieve the intended purposes of various modules.

In some embodiments, the one or more computing systems 100 may include or, either directly or indirectly through the various resources 128, invoke a set of modules 152 including hardware modules and software modules or combinations of one or more hardware modules and one or more software modules. Each of these modules may include or function in tandem with electrical circuitry and one or more micro-processors each having one or more processor cores to perform its intended functions.

The hardware system may further include one or more forms of non-transitory machine-readable storage media or persistent storage devices to temporarily or persistently store various types of data or information, various design rules, various libraries, selected and selectable targets, or any other suitable information or data, etc. A module described herein is initialized in a computing system so that the software portion of the module is stored in memory (e.g., random access memory) to be executed by one or more processors or processor cores off the computing system to perform at least a part of the functionality of the module. Some illustrative modules or components of the hardware system may be found in the System Architecture Overview section below.

The set of modules 152 may comprise one or more rule modules 102 that include or function in tandem with one or more processor of the computing system 100 or one or more servers 150 to apply one or more rules. For example, a rule module 102 may apply a staining order rule or a primary antibody rule to determine the temporal sequence of multiple antibodies in generating a multiplex immunoassay procedure. In some embodiments, the staining order or primary antibody rule may require a sequential multiplex immunoassay procedure to first proceed with the first antibody having the lowest relative strength index followed by one or more antibodies associated with gradually increasing relative strength indices.

As another example, a rule module 102 may apply a substrate or chromogen rule to determine a temporal sequence of applying a plurality of different chromogens to an antibody solution in the generation of an immunoassay procedure. In some embodiments, the substrate or chromogen rule may require that the first substrate or chromogen to be applied includes the chromogen that conjugates most strongly to an HRP (horseradish peroxidase) enzyme; that the second substrate or chromogen to be applied includes the substrate or chromogen that conjugates most strongly to an AP (alkaline phosphatase) enzyme; that the third substrate or chromogen to be applied includes the second strongest substrate or chromogen that conjugates to an AP enzyme; and that the fourth substrate or chromogen to be applied includes the second strongest substrate or chromogen that conjugates to an HRP enzyme.

A signal-cycle pair includes a signal having a particular value in a specific clock cycle and the specific clock cycle. An RDI or Why signal for an identified signal having a specific signal value in a particular clock cycle includes a signal that contributes to the specific signal value or the signal transition to the specific signal value in the particular clock cycle in some embodiments. It shall be noted that the term relevant driver identification (or RDI for abbreviation) and Why are used interchangeably throughout this application. The set of modules 152 may also include a recursive RDI module 104 that identifies a plurality of RDI signals for an identified signal-cycle pair comprising a target signal and a specific clock cycle at least by recursively applying multiple levels of RDI operations for the target signal as well as for one or more subsequently generated RDI signals in some embodiments.

The set of modules 152 may also include one or more hierarchical rule modules 108 that apply a plurality of sets of rules in a hierarchical manner with each application of one or more rules reducing the search space and hence the memory footprint occupied by the search space (e.g., a search space for storing secondary antibody candidates for a rule module 102 or a hierarchical rule module 108 to determine a secondary antibody for a primary antibody).

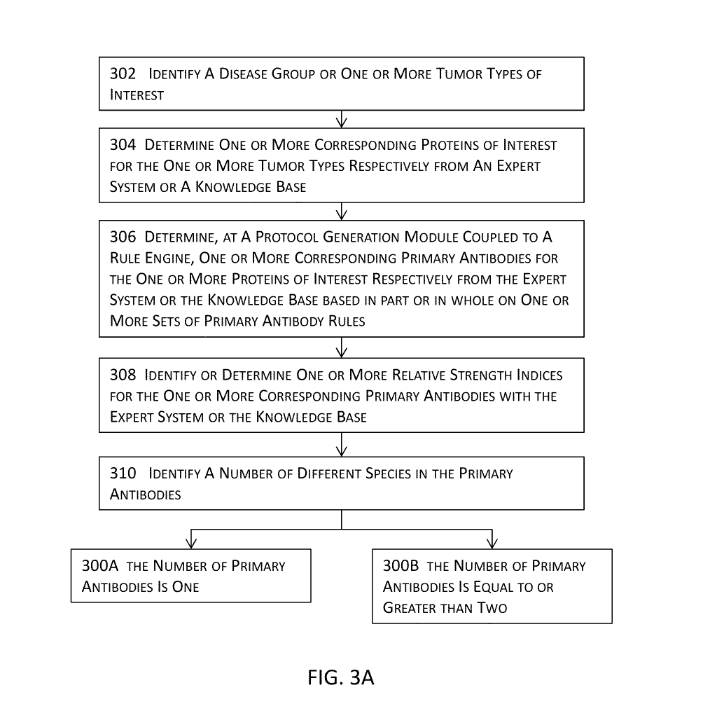

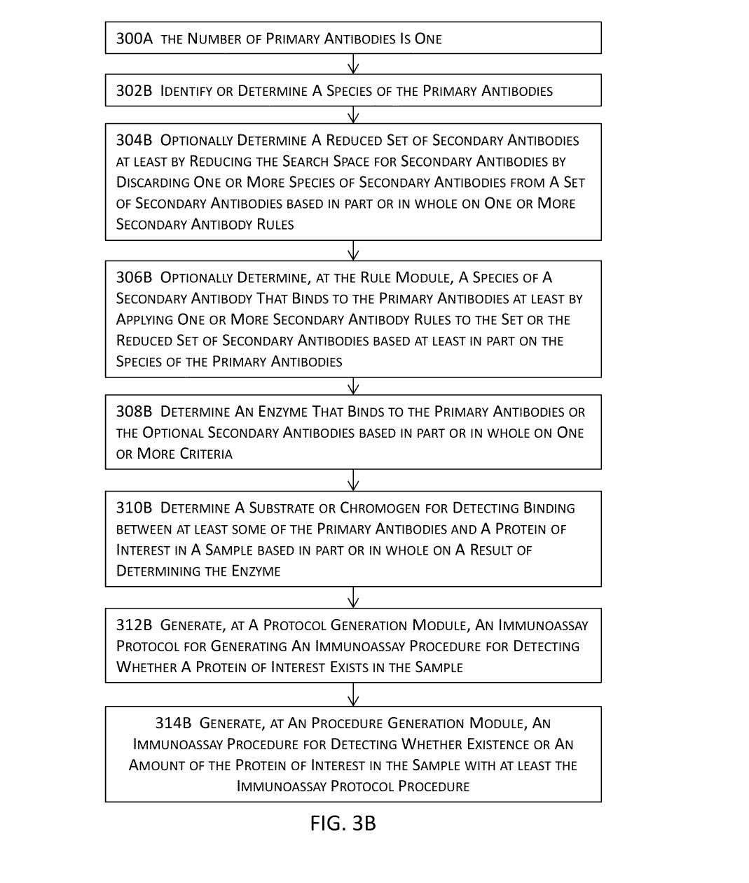

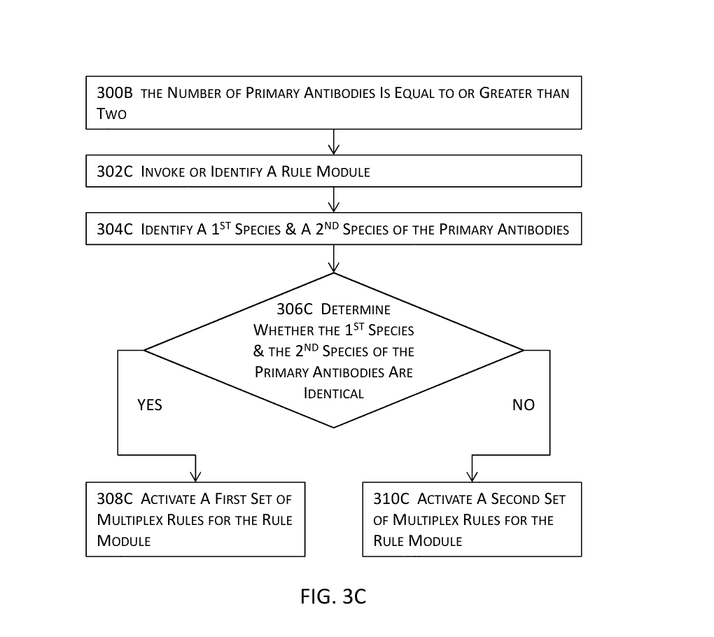

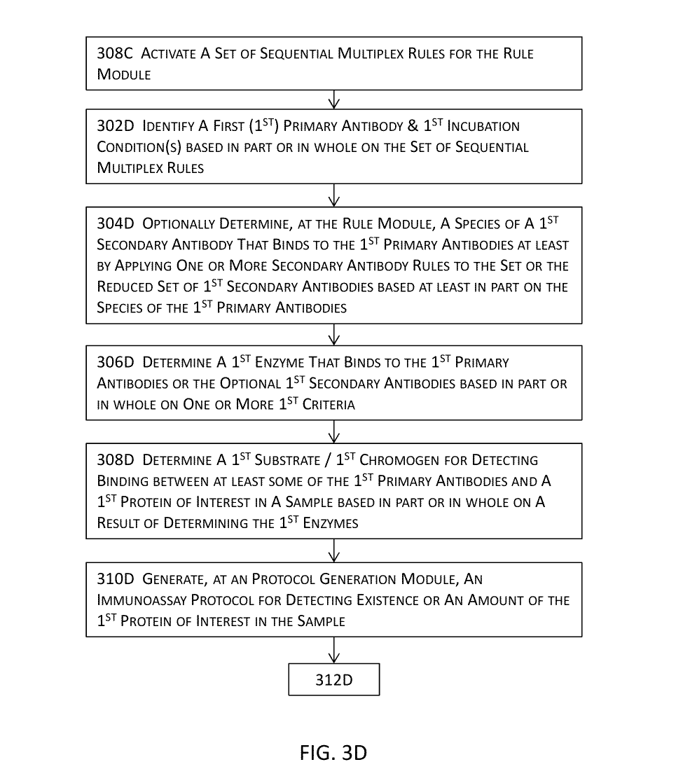

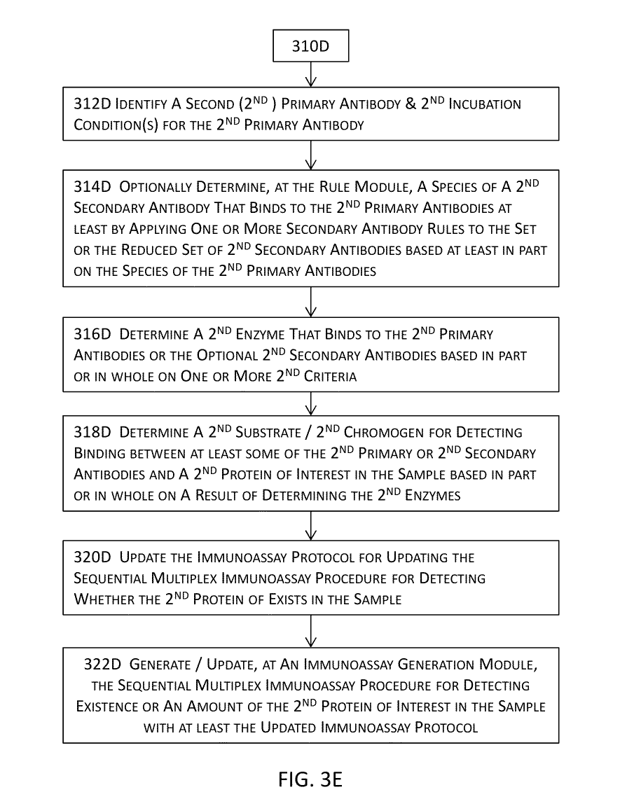

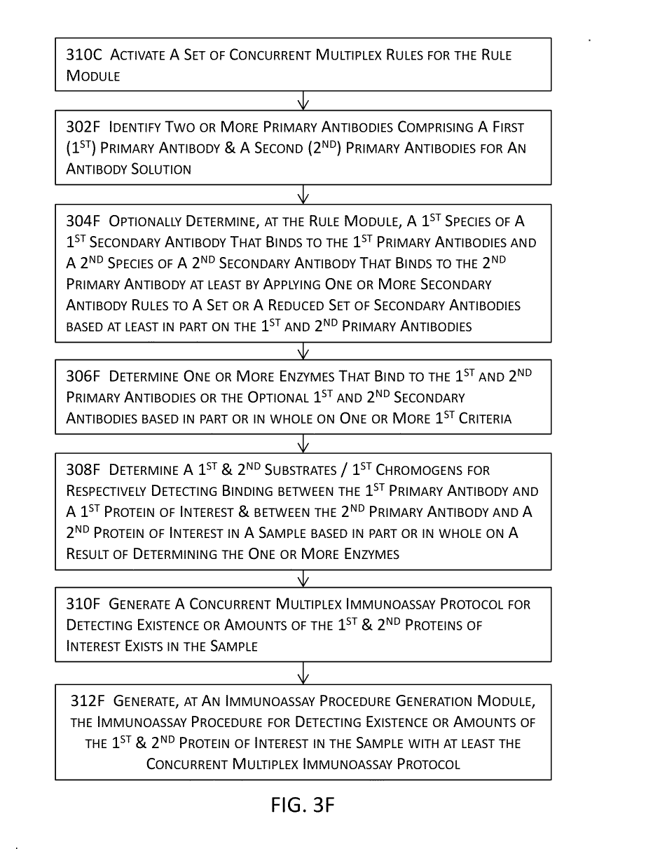

In some embodiments, the activation of one rule module or rules at one hierarchy automatically filters out certain candidates that are stored in a search space including one or more memory locations (e.g., one or more regions in the random access memory) that not only saves the amount of footprint occupied by the search space but also the runtime required to determine the appropriate candidates because various modules no longer need to consider these certain candidates. An example of a hierarchical application of rules with one or more hierarchical rule modules (e.g., 108) is provided in FIG. 3A where the number of species of primary antibodies is first identified. In some embodiments, different rules at a first hierarchy apply to reduce the search space for the optional secondary antibodies; and one or more other sets of rules apply at one or more additional, lower hierarchies to determine the appropriate enzymes and substrates or chromogens.

The set of modules 152 may also include one or more immunoassay protocol generation modules 104 that operate in conjunction with one or more modules (e.g., one or more rule modules 102, one or more hierarchical rule modules 108, an immunoassay procedure generation module 106, etc.) to automatically generate one or more immunoassay protocols with minimal or even no human intervention. The set of modules 152 may also include one or more immunoassay protocol generation modules 106 for generating an immunoassay procedure for a corresponding immunoassay protocol with the desired or required temporal sequence and corresponding experimental conditions for carrying out the immunoassay.

For example, a laboratory technician may, upon receiving a sample for diagnosis of a certain type of cancer, simply provide one or more tumor types of interest or a disease group (e.g., lung cancer), and various modules described herein automatically generate an immunoassay protocol including the one or more primary antibodies, the one or more optional secondary antibodies, one or more enzymes, and one or more substrates or chromogens in some embodiments. In some of these embodiments, various modules (e.g., the one or more immunoassay procedure generation modules 106) may further generate the corresponding immunoassay procedure with the desired or required temporal sequence and corresponding experimental conditions for carrying out the immunoassay.

The set of modules 152 may further optionally include an expert system or knowledge base 112 that operate along with other modules described herein to aid various decisions, determinations, and identifications. For example, an expert system or knowledge base may include or function in tandem with one or more models (e.g., 173) including, for example, a decision model, a statistical model, etc. that use one or more assumptions or one or more hypotheses to correlate various pieces of data. These one or more models may correlate various antibodies, chromogens, or substrates with various relative strength indices by using one or more assumptions or one or more hypotheses to respectively arrange these antibodies, chromogens, and substrates according to their respective relative strength indices.

These one or more assumptions, one or more hypothesis, and/or one or more models may be further subject to calibration or machine learning (e.g., via the calibration or machine learning module 110) with datasets that have not been used in generating these one or more models. For example, a result dataset generated by using an immunoassay procedure generated by the procedure generation modules 106 may be further used to example calibrate, for example, an assumption or hypothesis regarding relative strength indices of multiple antibodies. As another example, strength indices or values of some antibodies may be provided by different manufacturers, while no correlation exists among the relative strengths of these antibodies with respect to each other.

The expert system or knowledge base 112 may determine the relative strength indices for these antibodies to have a normalized set of relative strength indices for all antibodies in the database by using training datasets comprising historical data of various immunoassay results. These one or more assumptions, may further calibrate these relative strength indices, one or more hypothesis, one or more assumptions, and/or one or more models may be further subject to calibration or machine learning by using one or more test datasets of data that have not been used as a part of the training datasets or data that are subsequently acquired (e.g., results from the actual performance of immunoassay procedures generated by the procedure generation module 106).

The one or more calibration or machine learning modules 110 may then use one or more test datasets to validate these relative strength indices, one or more hypothesis, one or more assumptions, and/or one or more models or logic therein.

For example, a first antibody having a strength index of strong (or a numeric value of “5”) may be provided by manufacturer A, and a second antibody of the same species (e.g., the mouse type, the rabbit type, etc.) having a strength index of strong (or a symbolic value of “A”) may be provided by manufacturer B. These two antibodies are both assigned a strong strength index for certain types of tumor types by different manufacturers although in a completely uncorrelated context.

The expert system or knowledge base 112 may determine a first relative strength index (e.g., a textual string “strong”, a color “red”, or a numeric value “9.2”, etc.) for the first antibody and a second relative strength index (e.g., a textual string “medium-strong”, a color “orange”, or a numeric value “8.6”, etc.) for the second antibody by using some training datasets comprising some historical data such as the data obtained from the performance of one or more immunoassays involving both the first antibody and the second antibody. By determining the relative strength indices for antibodies, the strength indices of various antibodies may be normalized to a uniform scale to facilitate various functions of various modules described herein. An immunoassay protocol and a corresponding immunoassay procedure may be generated based in part or on whole upon these two relative strength indices.

When test datasets become available (e.g., other data not used in the determination of relative strength indices, other data acquired by the actual performance of the immunoassay with the generated immunoassay procedure, etc.), such test datasets may be used to validate these two relative strength indices. If the results are consistent, these two relative strength indices may be maintained as they are. Otherwise, the calibration or machine learning modules 110 may be invoked to calibrate these two relative strength indices or to further determine whether and how the logic in determining the original relative strength indices are to be calibrated.

In some embodiments, the set of modules 152 may further optionally include a database index module 114 that indexes one or more database tables with one or more indices. For example, a database table storing various antibodies (e.g., primary antibodies, secondary antibodies, etc.) may be indexed by using one or more database indices to facilitate the identification of antibodies, enzymes, and/or substrates, etc. to construct immunoassay protocols or immunoassay procedures. When a piece of data is stored on a persistent storage (e.g., in a database table in a disk based storage device), this piece of data may be stored as one or more blocks of data that are accessed in their entirety, making these one or more blocks the atomic disk access operation.

A database table may be indexed with one or more unique or non-unique database indices or keys. For example, a database table comprising antibodies may be indexed with the disease groups (or any other suitable database index) in some embodiments. In these embodiments, the database table may be sorted on the field of disease groups as a part of the indexing operation. Generating an index on a field in a database table creates another data structure which holds the field value, and a pointer to the record it relates to. This index structure is then sorted, allowing binary searches to be performed on it.

One of the advantages of indexing a database table is that by indexing the database table, any search to identify an element from the database table may be done with a binary search, instead of a linear search for non-indexed database tables. Runtime in identifying an element from such an indexed database table is reduced because a linear search on a non-indexed database table having a number (N) of blocks requires N/2 accesses on average, whereas a binary search on the same database having N blocks requires only log₂N accesses on average. In some of these embodiments, this database table may be further indexed with one or more additional database indices or keys. For example, the same database table may be further indexed with the tumor types, the relative strength indices, the enzymes, the substrates, or any combinations thereof, etc.

In some embodiments, the computing system 100 may include the various resources 128 such that these various resources may be invoked from within the computing system via a computer bus, an intranet, or an Internet 180 (e.g., a data bus interfacing a microprocessor 192 and the non-transitory computer accessible storage medium 198 or a system bus, an intranet, or an Internet 190 between a microprocessor 192 and one or more engines in the various resources 128). In some other embodiments, some or all of these various resources may be located remotely from the computing system 100 such that the computing system may access the some or all of these resources via a computer bus 180 and one or more network components.

Some or all of these various resources in 128 and 162 as well as various modules in 152 may be installed locally on a client computing device (e.g., 100) or remotely on or more servers 150 for user computing devices (e.g., 100) to access. In some embodiments, various modules and resources described herein are provided as a stand-along, self-contained computer program, while in some other embodiments, various modules and resources described herein are provided as software as a service (SaaS). In some embodiments, various modules and resources described herein are provided as cloud-based software program suite running off, for example, the one or more servers 100.

The computing system may also include one or more modules in the set of modules 152. One or more modules in the set 152 may include or at least function in tandem with a microprocessor 192 via a computer bus 194 in some embodiments. In these embodiments, a single microprocessor 192 may be included in and thus shared among more than one module even when the computing system 100 includes only one microprocessor. A microprocessor may further access some non-transitory memory (e.g., random access memory or RAM) via a system bus to read and/or write data during the microprocessor's execution of processes.

These one or more protocol generation modules 104 in the set of modules 152 may generate one or more protocols, and the one or more procedure generation modules 106 may generate one or more immunoassay procedures. Immunoassay procedures may be generated in many different electronic formats including one or more proprietary formats that are accessible by various automated equipment 140 such as various automated staining equipment. An immunoassay procedure may be transmitted from a immunoassay procedure generation module 106 to an automated equipment 140 via one or more network components (e.g., the Internet, an intranet, etc.) in some embodiments or to a removable storage device (e.g., a flash memory) that may be accessed by the automated equipment 140 in some other embodiments. In these embodiments, an immunoassay procedure may be read by the automated equipment as an input to instruct the automated equipment to facilitate the performance of immune-staining according to the procedural sequence set in the immunoassay procedure.

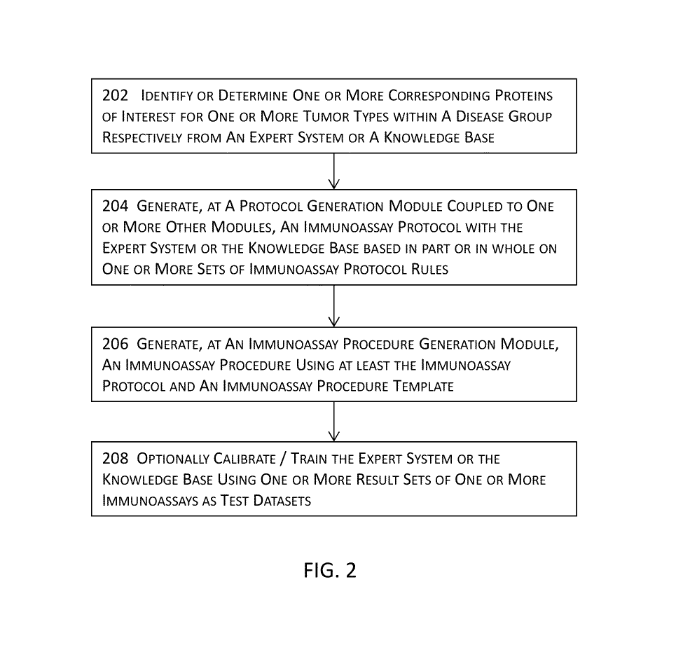

FIG. 2 illustrates a high level block diagram for implementing knowledge base-driven generation of immunoassay protocols and procedures in one or more embodiments. One or more corresponding proteins of interest may be determined or identified or determined at 202 for a disease group or one or more tumor types in a disease group. In some embodiments, a user (e.g., a laboratory technician or pathologist) may provide a disease group (e.g., lung cancer), and various modules described herein identify a default set of one or more tumor types of interest and automatically generate an immunoassay protocol or even an immunoassay corresponding to the immunoassay protocol for performing the immunoassay to detect the existence or amounts of one or more proteins of interest in a sample.

In some other embodiments, a user may provide one or more tumor types of interest, and various modules described herein automatically generate an immunoassay protocol or even an immunoassay corresponding to the immunoassay protocol for performing the immunoassay to detect the existence or amounts of one or more proteins of interest corresponding to the one or more provided tumor types in a sample. The one or more data structures (e.g., a relational or non-relational database) may store the data or information of various disease groups and their one or more corresponding tumor types of interest such that their relationship or correlation may be quickly accessed via, for example, database queries.

In some embodiments described herein, the disease group may include the diseases as illustrated in Table 1 as presented below.

TABLE 1
Disease Group

Undifferentiated 2
Lung
Breast
Gastrointestinal
Urinary
Mediastinum
Head and Neck
Prostate
Undifferentiated 1
Pancreas
Liver
Kidney
Adrenal
Thyroid
Pleura
Abdomen
Urinary Track (female)
Bladder
Testis
Central Nervous System
Skin

In some embodiments described herein, the disease group of “Undifferentiated 2” may include, for example, the tumor types of Thymoma, Lymphoma, Hodgkin's Disease, Hepatocellular Carcinoma, Rhabdomyosarcoma, Leiomyosarcoma, Melanoma, or Renal Cell Carcinoma.

In some embodiments described herein, the disease group of “Lung” may include, for example, the tumor types of Small Cell Carcinoma, Squamous Cell Carcinoma, Adenocarcinoma, Metastatic Renal Cell Carcinoma, Metastatic Breast Carcinoma, Lymphocytic Infiltrate, Ewing's Sarcoma, Histiocytosis, Desmoplastic Mesothelioma, Fibrous Tumor, Synovial Sarcoma, or Reactive Mesothelium.

In some embodiments described herein, the disease group of “Breast” may include, for example, the tumor types of Ductal Breast Carcinoma, Ductal Adenosis, Metastatic Breast Carcinoma, or Medullary Breast Carcinoma.

In some embodiments described herein, the disease group of “Gastrointestinal” may include, for example, the tumor types of Gastrointestinal Stromal Tumor, Leiomyosarcoma, Metastatic Carcinoma, Colon Adenocarcinoma, Lymphoma, Adenocarcinoma, Ovarian Carcinoma, or Carcinoid.

In some embodiments described herein, the disease group of “Urinary” may include, for example, the tumor types of Prostate Carcinoma, Metaplastic Carcinoma, Prostate Hyperplasia, Urothelial Cell Carcinoma, Colon Adenocarcinoma, Low Grade Urothelial Cell Carcinoma, High Grade Urothelial Cell Carcinoma, or Invasive Urothelial Cell Carcinoma.

In some embodiments described herein, the disease group of “Mediastinum” may include, for example, the tumor types of Thymoma, Lymphoma, Hodgkin's Disease, Hepatocellular Carcinoma, Cholangiocarcinoma, Metastatic Colon Carcinoma, Renal Cell Carcinoma, Lung Adenocarcinoma, Small Cell Lung Carcinoma, Adrenocortical Tumor, Urothelial Cancer, Metastatic Lung Cancer, Prostate Cancer, Gastrointestinal Stromal Tumor, Melanoma or Angiomyolipoma.

In some embodiments described herein, the disease group of “Head and Neck” may include, for example, the tumor types of Nasopharyngeal Carcinoma, Olfactory Neuroblastoma, Benign Lymphoepithelial Leision, or Squamous Cell Carcinoma.

In some embodiments described herein, the disease group of “Prostate” may include, for example, the tumor types of Prostatic Carcinoma In Situ, Invasive Prostate Carcinoma, or Benign Prostatic Hyperplasia.

In some embodiments described herein, the disease group of “Undifferentiated 1” may include, for example, the tumor types of Carcinoma (large, small, spindle), Melanoma, Large Cell Lymphoma, Ewing's Sarcoma, or Rhabdomyosarcoma.

In some embodiments described herein, the disease group of “Pancreas” may include, for example, the tumor types of Islet Cell Tumor, Ductal Adenocarcinoma, or Acinic Cell Carcinoma.

In some embodiments described herein, the disease group of “Liver” may include the tumor types of Hepatocellular Carcinoma, Metastatic Adenocarcinoma, Renal Cell Carcinoma, Cholangiocarcinoma, Colon Carcinoma, or Adrenocortical Carcinoma.

In some embodiments described herein, the disease group of “Kidney” may include, for example, the tumor types of Renal Cell Carcinoma, Urothelial Carcinoma, Angiomyolipoma, Metastatic Lung Carcinoma, Adrenocortical Tumor, or Sarcomatoid Renal Carcinoma.

In some embodiments described herein, the disease group of “Adrenal” may include, for example, the tumor types of Metastatic Carcinoma, Adrenocortical Tumor, or Pheochromocytoma.

In some embodiments described herein, the disease group of “Thyroid” may include, for example, the tumor types of Parathyroid Adenoma, Thyroid Medullary Carcinoma, Thyroid Clear Cell Carcinoma, Renal Cell Carcinoma, or Thyroid Follicular Carcinoma.

In some embodiments described herein, the disease group of “Pleura” may include, for example, the tumor types of Solitary Fibrous Tumor, Lung Adenocarcinoma, Synovial Sarcoma, Reactive Mesothelium, or Malignant Mesothelioma.

In some embodiments described herein, the disease group of “Abdomen” may include, for example, the tumor types of Cystic Mesothelioma, Lymphangioma, Peritoneal Mesothelioma, Hemangioma, Neuroblastoma, or Wilms Tumor.

In some embodiments described herein, the disease group of “Urinary Track (female)” may include, for example, the tumor types of Adenocarcinoma of Cervix, Endometrial Stromal Sarcoma, Benign Glandular Hyperplasia, Adenocarcinoma of Endometrium, Sex Chord Stromal Tumor, Ovarian Carcinoma, Uterine Leiomyosarcoma, Ovarian Epithelial Tumor, or Metastatic Colon Carcinoma.

In some embodiments described herein, the disease group of “Bladder” may include, for example, the tumor types of Metaplastic Carcinoma, Prostatic Adenocarcinoma, Urothelial Carcinoma, or Colon Adenocarcinoma.

In some embodiments described herein, the disease group of “Testis: may include, for example, the tumor types of Seminoma, or Embryonal Carcinoma.

In some embodiments described herein, the disease group of “Central Nervous System” may include, for example, the tumor types of Metastatic Melanoma, Schwannoma, Metastatic Carcinoma, High Grade Glioma, or Menigioma.

In some embodiments described herein, the disease group of “Skin” may include, for example, the tumor types of Melanoma In Situ, Bowen Disease, Small Cell Lung Carcinoma, Kaposi Sarcoma, Leiomyosarcoma, Merkel Cell Carcinoma, Dermatofibroma, Leukemic Infiltrate, Sebaceous Carcinoma, Desmoplastic Melanoma, Dermatofibrosarcoma, Histocytic Skin Reaction, Lymphoma, or Paget Disease.

A protocol generation module (e.g., the immunoassay protocol generation modules 104) may function in conjunction with one or more other modules (e.g., a rule module, a hierarchical rule module, etc.) generate an immunoassay protocol at 204 with the expert system or knowledge base based in part or in whole upon one or more sets of immunoassay protocol rules. These one or more sets of immunoassay protocol rules are referenced by the immunoassay protocol generation module with one or more rule modules or one or more hierarchical rule modules to identify or determine, for example, one or more primary antibodies, one or more optional secondary antibodies, one or more enzymes conjugated to the one or more primary antibodies (when no secondary antibodies are identified) or the one or more optional secondary antibodies (when the one or more secondary antibodies are identified), and one or more substrates or chromogens to construct the immunoassay protocol for the one or more tumor types of interest or the disease group identified at 202. More details about immunoassay protocol rules will be described below with reference to FIGS. 3A-B, 4A-B, and 5A-B.

In some embodiments described herein, the term “immunoassay” refers to a biochemical testing method that measures the presence or concentration of a molecule in a solution or in a solid phase, through the use of an antibody or immunoglobulin. Protein is one example being detected by an immunoassay. Common format of an immunoassay may include immunohistochemistry (IHC). immunocytochemistry (ICC) or the enzyme-linked immunosorbent assay (ELISA). IHC and ICC are closely related methods and they differ in the sample preparation. Immunohistochemistry deals primarily with tissues, such as may be obtained by a surgical procedure, immunocytochemistry relates to cells, usually obtained by aspiration with a needle and syringe, such as a fine needle aspirate (FNA). In contrast, immunocytochemistry deals with cells, such as may be obtained by swab, scrapes, or any laboratory or clinical techniques that allow intact cells to be collected. In both cases the end result is a microscope slide that contains individual cells rather than tissues. At this point the microscope slides are handled and processed similarly whether the sample is a tissue or individual cells.

An immunoassay procedure generation module function in tandem with the expert system or knowledge base may generate at 206 an immunoassay procedure. In some embodiments where an immunoassay protocol is generated at 204, the immunoassay procedure may be generated at 206 based on the immunoassay protocol. In some other embodiments, an immunoassay procedure may be generated independent of the generation of the corresponding immunoassay protocol. An immunoassay procedure may be generated using an immunoassay procedure template that is selected from a repository of immunoassay procedure templates in some embodiments.

At 208, the expert system or knowledge base or a portion thereof may be trained, retrained, or calibrated by using appropriate datasets. The appropriate datasets may include, for example, results of performing one or more immunoassays with the corresponding immunoassay procedures or corresponding immunoassay protocols or data that have not been used to determine, construct, or train the expert system or knowledge base. For example, a staining order may require that the application of a plurality of primary antibodies start with the weakest antibody having the lowest or smallest relative strength index and proceed with antibodies having gradually increasing relative strength indices in a sequential multiplex immunoassay in some embodiments.

In these embodiments, the relative strength indices of antibodies may be characterized by using, for example, some historical data as one or more training datasets. These relative strength indices may be further validated with one or more test datasets that have not been used as a part of the one or more training datasets. These one or more test datasets may come from, for example, other historical data or results from the actual performance of immunoassays with one or more immunoassay protocols or one or more immunoassay procedures generated by various modules described herein.

FIG. 3A illustrates a more detailed block diagram for implementing knowledge base-driven generation of immunoassay protocols and procedures in one or more embodiments. In these one or more embodiments, a disease group of interest or one or more tumor types of interest may be identified at 302. A disease group of interest or one or more tumor types of interest may be provided by, for example, a user after receipt of a sample for diagnosis. For example, a user may identify a disease group of interest (e.g., lung cancer), and various modules described herein may identify a default set of one or more default tumor types for generation of an immunoassay protocol or an immunoassay procedure for detecting the presence or amounts of one or more proteins of interest for the provided disease group of interest in the sample in some embodiments.

As another example, a user may specify one or more tumor types of interest (e.g., adenocarcinoma, mesothelioma, Ewing's sarcoma, lymphocytic infiltrate, etc.) in addition to or in the alternative of a disease group of interest (e.g., lung cancer), and various modules described herein may identify a default set of one or more default tumor types for generation of an immunoassay protocol or an immunoassay procedure for detecting the presence or amounts of one or more proteins of interest for the provided one or more tumor types of interest and/or the disease group of interest in the sample in some embodiments.

One or more corresponding proteins of interest may be determined at 304 for the one or more tumor types and/or the disease group of interest respectively from an expert system or a knowledge base. In some embodiments, the expert system or the knowledge base may include a one-to-one mapping between a tumor type of interest and a protein of interest. The expert system or the knowledge base may further including the information that associates at least one primary antibody with one protein of interest or one tumor type of interest. One or more experimental conditions, one or more characteristics or properties (e.g., relative strength indices of antibodies), or one or more rules (e.g., one or more protocol generation rules, one or more procedure generation rules, or any combinations thereof, etc.) may also be associated with a disease group, a tumor type of interest, or an antibody, etc.

The one or more experimental conditions may include, for example, duration, temperature, humidity, etc. and may depend on the samples, environmental conditions, etc. In some embodiments, each reagent or procedural step may correspond to a plurality of experimental conditions, and various modules may also sort or order the plurality of experimental conditions according to, for example, their impact on one or more metrics including effectiveness, accuracy, etc. Various disease groups, tumor types of interest, primary antibodies, the relations or mappings, various experimental conditions, various rules, etc. may be stored and managed in one or more data structures such as a non-relational or relational database.

The database may be further indexed with one or more different types of database indices to facilitate more efficient retrieval of information or data from the database. For example, the database may be indexed by using various disease groups, various tumor types, the primary antibodies (the secondary antibodies, various enzymes, various substrates, etc.), or various rules, etc. as database indices such that these database indices may be used to facilitate more efficient access (e.g., data retrieval, database queries, etc.) to the database. As a practical example, the database having N blocks of data records may be indexed by using the relative strength indices as the database indices. The database may then be sorted according to the relative strength indices. With indexing, a data block may be retrieved by the performance of a linear search that requires, on average, N/2 block accesses. With indexing as provided in this example, the same data block may be retrieved by the performance of a binary search that requires, on average, log₂N block accesses. As a result, the database so indexed saves runtime in accessing the database.

A protocol generation module (e.g., 103 in FIG. 1) may respectively determine, at 306, one or more primary antibodies for the one or more proteins of interest with the expert system or knowledge base and one or more rule modules based in part or in whole upon one or more sets of primary antibody rules in a repository or rule deck of protocol generation rules. In some embodiments where a sequential multiplex immunoassay protocol is determined for a plurality of primary antibodies, a staining order may also be determined at 306 for the plurality of primary antibodies based in part or in whole upon one or more primary antibody rules.

For example, a primary antibody rule may require that the application of a plurality of primary antibodies start with the weakest antibody having the lowest or smallest relative strength index and proceed with antibodies having gradually increasing relative strength indices in a sequential multiplex immunoassay in some embodiments. Another example of a primary antibody rule may require that a primary antibody be determined based in part or in whole upon its specificity for binding to a protein of interest in some embodiments.

In some embodiments described herein, the term “primary antibody” refers to the first antibody in contact with the sample in an immunoassay. Primary antibodies possess high specificity and affinity to a particular antigen that allows the detection of analytes in various immunoassay formats. Primary antibodies may include various types such as IgG, IgA or IgM that are determined based on their structural and functional regions contained. Primary antibodies may include various forms such as monoclonal antibodies or polyclonal antibodies. Monoclonal antibodies are antibodies that are produce from a single cell line and are highly specific for a single epitope on a multivalent antigen. Polyclonal antibodies are antibodies that are produced by immunization of animals. Primary antibodies may be raised or generated against various animal species such as mouse, rabbit, rat or human.

One or more relative strength indices may be identified or determined at 308 for the one or more primary antibodies with the expert system or the knowledge base. As described above, a staining order may be determined when a sequential multiplex immunoassay (and hence a sequential multiplex immunoassay protocol or procedure) is needed to successfully detect the presence or amounts of one or more proteins of interest of the same species in a sample. The staining order may be subject to a rule that requires the application of these multiple primary antibodies start with the weakest primary antibody. These one or more relative strength indices may thus be used to determine the staining order for these multiple primary antibodies in some embodiments.

A number of primary antibodies or the number of different species for the one or more corresponding primary antibodies may be identified at 310. In some embodiments, the number of different species or the number of primary antibodies may be used with one or more primary antibody rules, which may be a part of the rule deck for protocol generation rules or procedure generation rules, to determine whether a concurrent multiplex immunoassay may be used to detect the presence or amounts of the one or more proteins of interest in the sample.

For example, a rule may require a sequential multiplex immunoassay when the one or more corresponding primary antibodies are of the same species. A sequential multiplex immunoassay requires the application of one primary antibody, the optional secondary antibody, the enzyme, and the substrate or chromogen to complete the reaction and detection before a subsequent application of another primary antibody, the optional secondary antibody, the enzyme, and the substrate or chromogen for subsequent reaction and detection.

As another, another rule may permit a concurrent multiplex immunoassay when each of a plurality of primary antibodies corresponds to a different species. For example, an antibody solution may include two species of primary antibodies—a mouse species primary antibody and a rabbit species primary antibody. This rule permits a concurrent multiplex immunoassay in which both antibodies, the optional secondary antibodies, and the corresponding enzymes may be applied concurrently. In some of these embodiments, the corresponding substrates or chromogens may also be applied concurrently, whereas the corresponding substrates or chromogens may be applied sequentially in some other embodiments to allow separate reaction and detection of the reactions. Depending on the number of primary antibodies identified at 310, the process flow may bifurcate to 300A where the identified number of primary antibodies is one (“1”) and 300B where the identified number of primary antibodies is two (“2”). The bifurcated flows 300A and 300B are described below with reference to FIGS. 3B-F.

FIG. 3B illustrates a more detailed block diagram for a portion of the block diagram illustrated in FIG. 3A for implementing knowledge base-driven generation of immunoassay protocols and procedures in one or more embodiments. More specifically, FIG. 3B illustrates a more detailed block diagram when the identified number of primary antibodies is one. In these embodiments, a species of the primary antibody is identified or determined at 302B. For example, a mouse species or type or a rabbit species or type may be identified or determined at 302B for the primary antibodies identified 306.

A reduced set of secondary antibodies may be optionally determined at 304B by reducing or truncating the search space for secondary antibodies at least by discarding one or more species of secondary antibodies from a set of secondary antibodies based in part or in whole upon one or more secondary antibody rules. In some of these embodiments, a secondary antibody rule may be used to filter out these one or more secondary antibodies so that various modules (e.g., a rule module, an expert system or knowledge base, the protocol generation module, the procedure generation module, etc.) need not consider and determine whether these one or more secondary antibodies may be selected for an immunoassay protocol or an immunoassay procedure.

In an example where a database is used to store various secondary antibodies, a secondary antibody rule may be used as a predicate in, for example, the WHERE clause of an SQL (structured query language) query so that only rows or blocks that are evaluated to be true and will be further considered as possible candidates for the immunoassay protocol or immunoassay procedure. In another example where rules are organized hierarchically by, for example, one or more hierarchical rule modules, any secondary antibodies in conflict with a secondary rule will be excluded from consideration. In these embodiments, rules may be used to save memory footprint occupied by secondary antibody candidates for consideration or to save runtime taken by various modules to evaluate a fewer number of secondary antibody candidates.

In some embodiments described herein, the term “secondary antibody” is the antibody that recognizes and binds to the primary antibody in an immunoassay.

One or more rule modules may also optionally determine, at 306B, a species of a second antibody that binds to the primary antibody at least by applying one or more secondary antibody rules to the set or the reduced set of secondary antibodies based in part or in whole upon the species of the primary antibody. For example, a first rule may require an anti-mouse secondary antibody when the primary antibody is of a mouse type. As another example, a second rule may require an anti-rabbit secondary antibody when the primary antibody is of a rabbit type. As another example where it is determined that the primary antibodies include only one rabbit type and one mouse type,

An enzyme that binds to the primary antibody or the optional secondary antibody may be determined at 308B based in part or in whole upon one or more criteria. In some embodiments where a secondary antibody is determined, the secondary antibody may be conjugated to an enzyme probe in some embodiments. The secondary antibody and the enzyme may be chemically coupled together via a polymer backbone in some of these embodiments. This polymer backbone structure may not only retain the binding characteristics of the secondary antibody but also include numerous enzymes such that the enzyme molecules are indirectly linked to the primary antibodies after binding to the secondary antibody.

Some examples of enzymes include horseradish peroxidase (HRP) and alkaline phosphatase (AP). It shall be noted that other enzymes for immunoassays may also be used and are thus considered within the scope of this disclosure. The one or more criteria upon which an enzyme is determined may include, for example, a performance requirement, effectiveness or results of the protocol, costs, customer's requests or preferences, or the user's preferences. Therefore, the enzyme determined at 308B may thus be subject to change by the user. For example, a user or customer may prefer AP over HRP and may thus override the HRP enzyme determined by various modules although a warning or flag may be thrown for further review or confirmation when the overriding enzyme exhibits inferior characteristics than the automatically determined enzyme.

A substrate or chromogen for detecting binding between the primary antibody and the protein of interest in the sample may be determined at 3108 based in part or in whole upon the enzyme determined at 308B. The enzyme determined at 308B is to react with a substrate or chromogen to produce a distinct colored end product that may be visualized with some aid such as a microscope. There may exist many chromogens associated with HRP producing colors such as brown, blue, black, and yellow. The colors generally associated with AP include red, blue, and green.

The choice of enzyme may thus dictate the choice of chromogens, which may further dictate the final color of the reaction. In some embodiments, the secondary antibody may be conjugated to a fluorescent probe, a fluorochrome, or a fluorophore, rather than an enzyme. In these embodiments, substrates or chromogens are not needed because Fluorescent labels emit light with a specific wavelength. Enzymatic labels such as HRP and AP or other kinds form a colored precipitate when combined with the appropriate substrate such as a fluorescent probe, a fluorochrome, or a fluorophore, etc. by itself emits light in a specific range of wavelengths and thus may be detected without a substrate or chromogen.

A substrate or chromogen determines the specific color and associates that color with a specific antibody. Chromogen may be identified and initially applied in a colorless solution yet becomes colored and precipitates onto the slide upon reaction with its enzyme in some embodiments. Chromogens may also retain their original color even when exposed to subsequent chromogens of different colors in some embodiments. This color retention characteristic may constitute an important consideration for multiplex immunoassays. In some embodiments, regardless of whether the immunoassay is sequential or concurrent, chromogens may be applied sequentially starting from the strongest chromogen and proceed through the weakest among the identified chromogens.

The order in which the chromogens are used may also affect the identification or determination of substrates or chromogens because some chromogens may alter the color of other chromogens. To prevent these undesirable chromogen interactions, some rules may impose an order for application of the chromogens. For example, a rule may require or desire the first substrate or chromogen to be the strongest substrate or chromogen for HRP; the second substrate or chromogen to be the strongest substrate or chromogen for AP; the third substrate or chromogen to be the second strongest substrate or chromogen for AP; and the fourth substrate or chromogen to be the second strongest substrate or chromogen for HRP in some embodiments. In these embodiments, the immunoassay procedure starts with the strongest substrate or chromogen paired with the weakest antibody and proceeds till the last stain that pairs the weakest substrate or chromogen with the strongest antibody to neutralize or reduce the relative strength of each of the stains resulting in a more balanced stain as opposed to randomly pairing antibodies and chromogens.

Because the secondary antibody may be conjugated to an enzyme probe, the first enzyme is thus narrowed down to the HRP in these embodiments. Furthermore, the secondary antibody may be used to link an enzyme to the primary antibody, the first secondary antibody to be applied is the anti-mouse HRP when the primary antibody is of the mouse species; and the secondary antibody may be used to link an enzyme to the primary antibody, the first secondary antibody to be applied is the anti-rabbit HRP when the primary antibody is of the rabbit species in these embodiments.

In addition, the second enzyme to be applied is AP because the second substrate or chromogen is the strongest substrate or chromogen for AP in these embodiments. As a result, the second secondary antibody, if needed, is an anti-mouse AP if the primary antibody is of the mouse-type; and the second secondary antibody, if needed, is an anti-rabbit AP if the primary antibody is of the rabbit-type. The aforementioned examples illustrate the a dependency relationship between multiple rules and hence the logic in determination or identification of various reagents for an immunoassay protocol or an immunoassay procedure as well as the filtering effects of one or more rules on the search space to improve the efficiency and functioning of the computing system (e.g., the user computing device 102 or the one or more servers 150 in FIG. 1).

The protocol generation module may then generate an immunoassay protocol at 3128. In some embodiments, an immunoassay procedure may also be generated by the procedure generation module at 314B for detecting the existence or an amount of the protein of interest in the sample. It shall be noted that although an immunoassay procedure may be generated based on the corresponding immunoassay protocol, an immunoassay procedure may be generated absent and independent of the determination of the corresponding immunoassay protocol in advance in some embodiments by utilizing similar techniques described above.

In some embodiments, the immunoassay procedure may be transmitted at 316B to automated equipment (e.g., an automated immune-stainer). Immunoassay procedures may be generated in many different electronic formats including one or more proprietary formats that are accessible by various automated equipment (e.g., reference numeral 140 in FIG. 1) such as various automated staining equipment or automated stainer. The automated staining equipment may access the immunoassay procedure as an input in some embodiments, or the immunoassay procedure may include machine accessible code to drive the automated equipment to perform the immunoassay according to the procedural sequence set forth in the immunoassay procedure.

In some embodiments, an immunoassay procedure may be generated in a specific format as required by particular automated staining equipment. In some of these embodiments, the immunoassay procedure may be generated according to a template specifically designated for the particular automated staining equipment. Some embodiments further invoke a translator, a compiler, a mapping, or a transformation, etc. to translate, compile, map, or transform an immunoassay procedure from one format to another format,

An immunoassay procedure generated by various modules described herein (e.g., a procedure generation module) may be transmitted to automated staining equipment in various different ways. In some embodiments, an immunoassay procedure may be transmitted to automated staining equipment via one or more network components such as the Internet, an intranet, or a wide-area network. In some other embodiments, an immunoassay procedure may be stored in a persistent storage (e.g., flash memory, an optical disk, an external storage device, etc.) that may be accessed by automated staining equipment.

FIG. 3C illustrates a more detailed block diagram for a portion of the block diagram illustrated in FIG. 3A for implementing knowledge base-driven generation of immunoassay protocols and procedures in one or more embodiments. More specifically, FIG. 3C illustrates a block diagram for the embodiments where the number of species of the primary antibodies is equal to or greater than two. In these one or more embodiments, one or more rule modules may be invoked at 302C, and a first species and a second species may be identified at 304C. It may be further determined whether the first species and the second species of the primary antibodies are identical at 306C. If the determination result is affirmative, the process may proceed to 308C for sequential multiplex immunoassay. Otherwise, the process may proceed to 310C for concurrent multiplex immunoassay.

FIGS. 3D-E jointly illustrate a more detailed block diagram for a portion of the block diagram illustrated in FIG. 3C for implementing knowledge base-driven generation of immunoassay protocols and procedures in one or more embodiments. More specifically, FIGS. 3D-E illustrates the block diagram where the primary antibodies have two or more species that are identical. That is, the primary antibodies are of the same species (e.g., all mouse species, all rabbit species, etc.) One of the protocol generation rules may require a sequential multiplex immunoassay for multiple types of primary antibodies of the same species. In these embodiments, a set of sequential multiplex rules may be activated at 308C for the one or more rule modules.

FIGS. 3D-E also illustrate the application of a protocol generation rule that require a sequential multiplex process when the primary antibodies to be applied includes two or more primary antibodies from the same species in some embodiments. FIG. 3D-E also illustrate the application of another protocol generation rule that require the secondary antibodies be applied sequentially. In these embodiments, each primary antibody is applied sequentially, and the entire immunoassay is completed for a primary antibody before the application of another primary antibody. This sequential process is similar to single-stain IHC, except all the stains are applied to the same slide in a sequential manner.

At 302D, a first primary antibody and a first experimental condition may be identified based in part or in whole upon set of sequential multiplex rules. Primary antibody is the first antibody applied to the sample and has the capacity to bind to its specific protein of interest. This is the part of the immunoassay responsible for specificity. There are generally two types of primary antibodies—mouse antibodies and rabbit antibodies—depending on the animal species used to generate the antibody.

The one or more rule modules may optionally determine a species of a first secondary antibody that binds to the first primary antibody at least by applying one or more secondary antibody rules to the set of sequential multiplex rules at 304D. As described above, the application of a rule may effectively reduce the space of the set of applicable rules. Therefore, the set of sequential multiplex rules may be reduced into a reduced set of sequential multiplex rules by filtering our one or more rules by the application of one or more rules in some embodiments. In these embodiments where the set of sequential multiplex rules is reduced to a reduced set of sequential multiplex rules, the optional determination of the species of the first secondary antibody that binds to the first primary antibody at least by applying one or more secondary antibody rules to the reduced set of sequential multiplex rules at 304D.

A secondary antibody binds to a primary antibody and acts as an amplification layer in the immunoassay reaction. There are generally two types of secondary antibodies that are distinguished based on their specificity. The first type of secondary antibody is referred to as anti-mouse indicating that the secondary antibody has been engineered to specifically bind to mouse primary antibodies. The second type of secondary antibody is anti-rabbit indicating that this secondary antibody has been specifically engineered to bind to rabbit primary antibodies. The choice of secondary antibodies may thus be influenced by the choice of the primary antibodies. This further illustrates the dependency relationship between and hence a filtering effect of primary antibodies and secondary antibodies.

A first enzyme that binds to the first primary antibody or the optional secondary antibody may be determined at 306D based in part or in whole upon one or more first criteria. Some examples of these one or more first criteria are provided in the description above with reference to 308B. In addition, a first substrate or chromogen may be determined at 308D for detecting binding between the first primary antibody and a first protein of interest in the sample based in part or in whole upon a result of determining the first enzyme. The determination of the first enzyme and the first substrate or chromogen may be performed based on a set of rules such as those described with reference to 308B and 310B in FIG. 3B above. A protocol generation module may generate an immunoassay protocol at 310D for detecting the presence or an amount of the first protein of interest in the sample.

In these embodiments, the first secondary antibody to be applied includes anti-mouse HRP when the primary antibody is of the mouse species. On the other hand, the first secondary antibody to be applied includes anti-rabbit HRP when the primary antibody is of the rabbit species. In addition or in the alternative, the second secondary antibody to be applied includes anti-mouse AP when the primary antibody is of the mouse species; and the second secondary antibody to be applied includes anti-rabbit AP when the primary antibody is of the rabbit species.

A similar process may be repeated with one or more additional primary antibodies. At 312D, a second primary antibody and a second experimental condition may be identified based in part or in whole upon set of sequential multiplex rules.

The one or more rule modules may optionally determine a species of a second secondary antibody that binds to the second primary antibody at least by applying the one or more secondary antibody rules to the set of sequential multiplex rules at 314D. In some embodiments where the set of sequential multiplex rules is reduced to a reduced set of sequential multiplex rules, the optional determination of the species of the second secondary antibody that binds to the second primary antibody at least by applying the one or more secondary antibody rules to the reduced set of sequential multiplex rules at 314D.

A second enzyme that binds to the second primary antibody or the optional second secondary antibody may be determined at 316D based in part or in whole upon the one or more first criteria that are identical or substantially similar to those described with reference to 306D. Some examples of these one or more first criteria are provided in the description above with reference to 308B. In addition, a second substrate or chromogen may be determined at 318D for detecting binding between the second primary antibody and a second protein of interest in the sample based in part or in whole upon a result of determining the second enzyme.

The determination of the second enzyme and the second substrate or chromogen may be performed based on a set of rules such as those described with reference to 308B and 310B in FIG. 3B above. A protocol generation module may update the immunoassay protocol (generated at 310D) at 320D for detecting the presence or an amount of the second protein of interest in the sample. An immunoassay generation module may generate (if not yet existing) or update (if existing) a sequential multiplex immunoassay procedure for detecting the existence or the amount of the second protein of interest in the sample at 322D.

FIG. 3F illustrates a more detailed block diagram for a portion of the block diagram illustrated in FIG. 3C for implementing knowledge base-driven generation of immunoassay protocols and procedures in one or more embodiments. More specifically, FIG. 3F illustrates a concurrent multiplex process for generating a concurrent multiplex immunoassay protocol or procedure. A set of concurrent multiplex rules may be activated at 310C for the one or more rule modules. Two or more primary antibodies comprising a first primary antibody and a second primary antibody may be identified at 302F.

The one or more rule modules may optionally determine, at 304F, a first species of a first secondary antibody that binds to the first primary antibody and a second species of a second secondary antibody that binds to the second primary antibody at least by applying one or more secondary antibody rules to a set or a reduced set of secondary antibodies based in part or in whole upon the first and second primary antibodies identified at 302F. In some embodiments, the secondary antibody is conjugated to an enzyme probe. In some other embodiments, the secondary antibody may be conjugated to a fluorescent probe, a fluorochrome, or a fluorophore.

Fluorochromes have a wider range of available colors (wavelengths) from which to choose, thus expanding the number of multiplex stains that could be combined on a single slide.

The protocol generation module, the procedure generation module, or the one or more rule module may determine one or more enzymes that bind to the first and second primary antibodies or the optional first and second secondary antibodies at 306F based in part or in whole upon one or more criteria identical or substantially similar to those described with reference to FIG. 3B.

A first and second substrates or chromogens may be determined at 308F for respectively detecting binding between the first primary antibody and a first protein of interest and between the second primary antibody and a second protein of interest in the sample based in part or in whole upon the results of determining the one or more enzymes at 306F. In some embodiments, regardless of whether the immunoassay is sequential (e.g., FIGS. 3D-E) or concurrent (e.g., FIG. 3F), chromogens may be applied sequentially starting from the strongest chromogen and proceed through the weakest among the identified chromogens.

The protocol generation module may generate a concurrent multiplex immunoassay protocol at 310F for detecting existence or amounts of the first and second proteins of interest in the sample. The procedure generation module may generate a concurrent multiplex immunoassay procedure at 312F for detecting existence or amounts of the first and second proteins of interest in the sample. As described above, the concurrent multiplex immunoassay procedure may be generated based on the concurrent multiplex immunoassay protocol in some embodiments or independent of the concurrent multiplex immunoassay protocol in some other embodiments. The concurrent multiplex immunoassay procedure allows the application of a mixture of primary antibodies of different species or different specificities (e.g., mouse species and rabbit species). The concurrent multiplex immunoassay procedure also allows the application of a mixture of secondary antibodies of different species or different specificities (e.g., anti-mouse specificity and anti-rabbit specificity).

In some embodiments where the secondary antibody and the enzyme are chemically coupled together via a polymer backbone, the polymer may include a mixture of anti-mouse HRP and anti-rabbit AP. In some other embodiments, the polymer may include a mixture of anti-mouse AP and anti-rabbit HRP. In some of these embodiments, the first (e.g., the weakest) primary antibody may be linked with HRP. When the first primary antibody is of the mouse species, then the correct polymer may include a mixture of anti-mouse HRP plus anti-rabbit AP. When the first primary antibody (e.g., the weakest primary antibody) is of the rabbit species, the polymer may include anti-rabbit HRP plus anti-mouse AP.

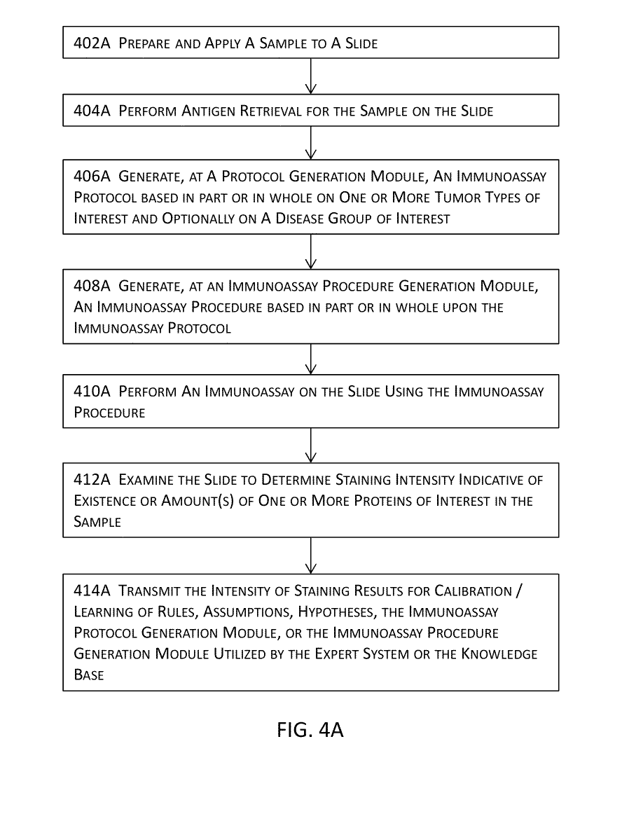

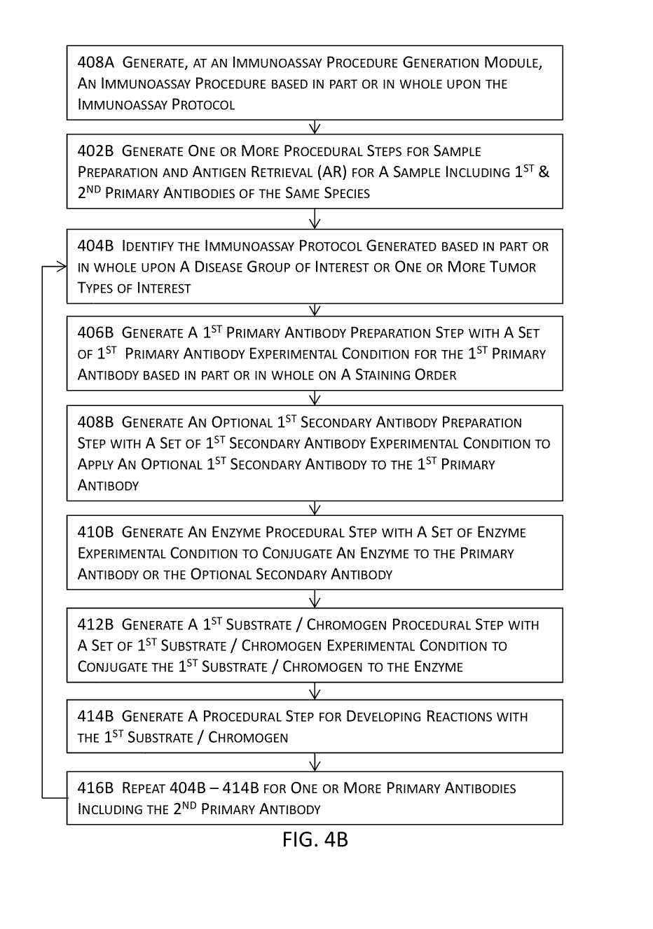

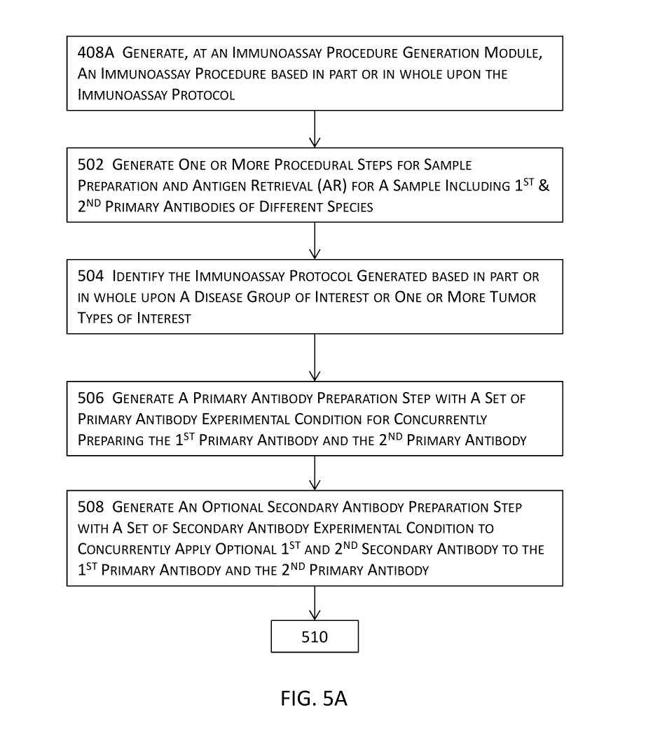

FIG. 4A illustrates a high level block diagram for implementing knowledge base-driven generation of immunoassay protocols and procedures in one or more embodiments. More specifically, FIG. 4A illustrates a standard immunoassay that may be performed with an immunoassay protocol or an immunoassay procedure generated by various modules described herein. At 402A, a sample may be prepared and applied to a slide. Antigen retrieval may be performed at 404A for the sample on the slide. A protocol generation module (e.g., 104 of FIG. 1) may generate, at 406A, an immunoassay protocol based in part or in whole on a disease group of interest or one or more tumor types of interest. Table 2 that is shown immediately below presents an example of a protocol.

TABLE 2

| | | Secondary | |
|---|---|---|---|
| Order of Stain | Primary Antibody | Antibody | Chromogen |
| 1 | TTF-1/Napsin A | Anti-mouse HRP | Brown |
| 2 | CD45/CD20 | Anti-mouse AP | Red |
| 3 | CD99 | Anti-mouse AP | Blue |
| 4 | Pan-cytokeratin | Anti-mouse HRP | Yellow |

A procedure generation module (e.g., 108 of FIG. 1) may generate, at 408A, an immunoassay procedure based on or independent of the corresponding immunoassay protocol. An immunoassay may be performed at 410A using the immunoassay procedure. The slide may be examined at 412A with, for example, a microscope, to determine staining intensity indicative of the existence or amounts of one or more proteins of interest in the sample. The staining intensity may be transmitted at 414A to, for example, the calibration or machine learning module to validate or calibrate, for example, one or more rules, one or more assumptions, one or more hypotheses, the logic in the immunoassay protocol generation module, or the logic in the immunoassay procedure generation module that is utilized by the expert system or knowledge base to generate immunoassay protocols or immunoassay procedures.

FIG. 4B illustrates a more detailed block diagram for a portion of the block diagram illustrated in FIG. 4A for implementing knowledge base-driven generation of immunoassay protocols and procedures in one or more embodiments. More specifically, FIG. 4B illustrates more details about 408A of FIG. 4A. In these one or more embodiments, one or more procedural steps may be generated at 402B for sample preparation and antigen retrieval for a sample that include a first primary antibody and a second antibody of the same species (e.g., both are of the mouse species or the rabbit species).

The immunoassay protocol that is generated based in part or in whole upon a disease group of interest or one or more tumor types of interest may be identified at 404B. A first primary antibody preparation step may be generated at 406B with a set of first primary antibody experimental conditions for the first primary antibody based in part or in whole on a staining order. In some of these embodiments, the staining order includes applying the weakest primary antibody first and proceeding with primary antibodies with gradually increasing strength till the strongest primary antibody.

An optional first secondary antibody preparation step may be generated at 408B with a set of first secondary antibody experimental conditions to apply the optional first secondary antibody to the first primary antibody. An enzyme procedural step may also be generated at 410B with a set of enzyme experimental condition to conjugate the enzyme to the primary antibody or the optional secondary antibody. In some embodiments, an enzyme rule may require the first enzyme by HRP; the second enzyme be AP; the third enzyme be AP; and the fourth enzyme by HRP. A first substrate or chromogen procedural step may be generated at 412B with a set of first substrate or chromogen experimental condition to conjugate the first substrate or chromogen to the enzyme. A procedural step may be generated at 414B for developing reactions with the first substrate or chromogen. The process steps 404B through 414B may be repeated for each of one or more additional primary antibodies until all the primary antibodies are similarly, sequentially processed.

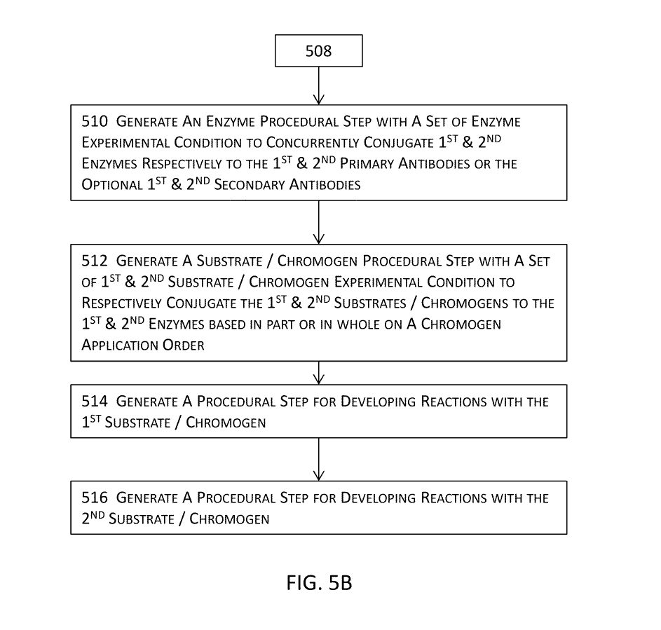

FIGS. 5A-B jointly illustrate a more detailed block diagram for a portion of the block diagram illustrated in FIG. 4A for implementing knowledge base-driven generation of immunoassay protocols and procedures in one or more embodiments. More specifically, FIGS. 5A-B jointly illustrate more details about 408A in some embodiments where the primary antibodies correspond to more than one species. In these embodiments, one or more procedural steps for sample preparation and antigen retrieval may be generated at 502 for a sample that comprises a first primary antibody and a second primary antibody corresponding to different species.

For example, the first primary antibody may correspond to the mouse species, and the second primary antibody may correspond to the rabbit species. The immunoassay protocol generated based in part or in whole upon a disease group of interest or one or more tumor types of interest may be identified at 504. A primary antibody preparation step may be generated at 506 with a set of primary antibody experimental conditions for concurrently preparing the first primary antibody and the second primary antibody. An option secondary antibody preparation step may be generated at 508 with a set of secondary antibody experimental conditions to concurrently apply the optional first secondary antibody and the second secondary antibody to the first primary antibody and the second primary antibody.

An enzyme procedural step may be generated at 510 with a set of enzyme experimental condition to concurrently conjugate the first and the second enzymes respectively to the first and second primary antibodies or to the optional first and second secondary antibodies. One or more substrate or chromogen procedural step may be generated at 512 with a set of substrate or chromogen experimental conditions to respectively conjugate a first substrate or chromogen and a second substrate or chromogen to the first and second enzymes based in part or in whole upon a substrate or chromogen application order.

In some embodiments, the substrate or chromogen application order requires a series of sequential procedural steps that sequentially conjugate each substrate or chromogen to the corresponding enzyme under its own experimental condition. A procedural step may be generated at 514 for developing reactions with the first substrate or chromogen. A subsequent procedural step may be generated at 516 for developing reactions with the second substrate or chromogen. In these embodiments, the processes at 512 through 516 are repeated for each substrate or chromogen until all the substrates or chromogens are similarly processed. In some other embodiments, the substrate or chromogen application order requires a single procedural step that concurrently and selectively conjugates substrates or chromogens to their corresponding enzymes under a single set of experimental conditions. In these latter embodiments, a single procedural step may be generated for developing reactions with all the substrates or chromogens.

### System Architecture Overview

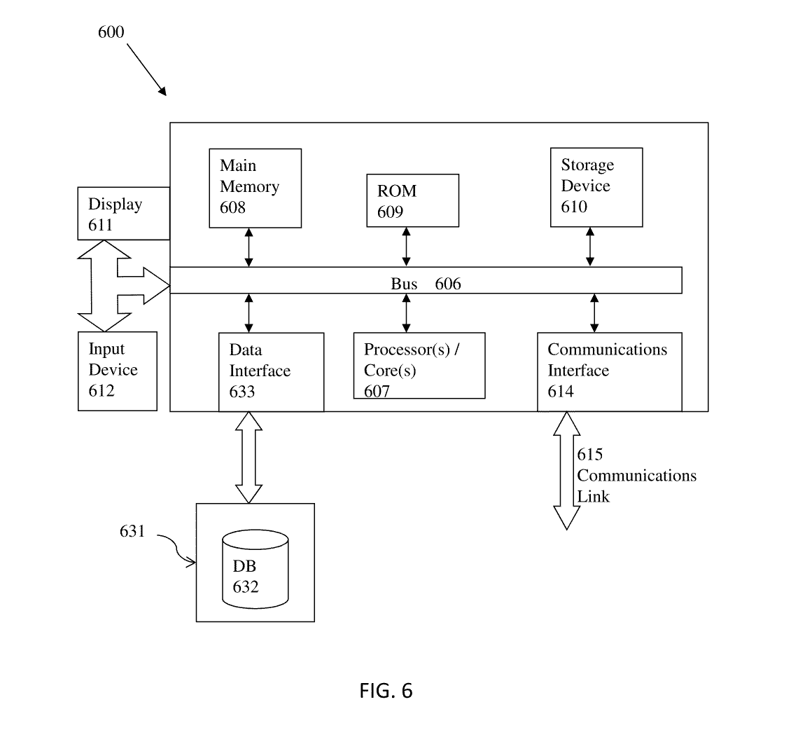

FIG. 6 illustrates a block diagram of an illustrative computing system 600 suitable for implementing knowledge base-driven generation of immunoassay protocols and procedures as described in the preceding paragraphs with reference to various figures. Computer system 600 includes a bus 606 or other communication module for communicating information, which interconnects subsystems and devices, such as processor 607, system memory 608 (e.g., RAM), static storage device 609 (e.g., ROM), disk drive 610 (e.g., magnetic or optical), communication interface 614 (e.g., modem or Ethernet card), display 611 (e.g., CRT or LCD), input device 612 (e.g., keyboard), and cursor control (not shown).

According to one embodiment, computing system 600 performs specific operations by one or more processor or processor cores 607 executing one or more sequences of one or more instructions contained in system memory 608. Such instructions may be read into system memory 608 from another computer readable/usable storage medium, such as static storage device 609 or disk drive 610. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

Various actions or processes as described in the preceding paragraphs may be performed by using one or more processors, one or more processor cores, or combination thereof 607, where the one or more processors, one or more processor cores, or combination thereof executes one or more threads. For example, various acts of determination, compression, decompression, etc. may be performed by one or more modules (e.g., one or more modules described in FIG. 1) including or functioning in tandem with one or more processors, one or more processor cores, or combination thereof.

A module described herein may also be implemented as a pure hardware module (e.g., a block of electronic circuit components, electrical circuitry, etc.) or a combination of a hardware module and a software block that jointly perform various tasks to achieve various functions or purposes described herein or equivalents thereof. For example, a module described herein may be implemented as an application-specific integrated circuit (ASIC) in some embodiments.

In these embodiments, a module may be stored at least partially in memory and may also include or function in tandem with, for example, a microprocessor or a processor core and other supportive electrical circuitry to perform specific functions which may be coded as software or hard coded as a part of an application-specific integrated circuit, ROM (read only memory), PROM (programmable read only memory), EPROM (erasable programmable read only memory), etc. despite the fact that these microprocessor, processor core, and electrical circuitry may nevertheless be shared among a plurality of module. A module described herein or an equivalent thereof may perform its respective functions alone or in conjunction with one or more other modules. A module described herein or an equivalent thereof may thus invoke one or more other modules by, for example, issuing one or more commands or function calls. The invocation of one or more other modules may be fully automated or may involve one or more user inputs. To the extent that a module includes a piece of software, the software is stored in a non-transitory computer accessible storage medium such as computer memory.

The term “computer readable storage medium” or “computer usable storage medium” as used herein refers to any non-transitory computer accessible storage medium that participates in providing instructions to processor 607 for execution. Such a medium may take many forms, including but not limited to, non-volatile media and volatile media. Non-volatile media includes, for example, optical or magnetic disks, such as disk drive 610. Volatile media includes dynamic memory, such as system memory 608. Common forms of computer readable storage media includes, for example, electromechanical disk drives (such as a floppy disk, a flexible disk, or a hard disk), a flash-based, RAM-based (such as SRAM, DRAM, SDRAM, DDR, MRAM, etc.), or any other solid-state drives (SSD), magnetic tape, any other magnetic or magneto-optical medium, CD-ROM, any other optical medium, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 600. According to other embodiments of the invention, two or more computer systems 600 coupled by communication link 615 (e.g., LAN, PTSN, or wireless network) may perform the sequence of instructions required to practice the invention in coordination with one another.

Computer system 600 may transmit and receive messages, data, and instructions, including program, i.e., application code, through communication link 615 and communication interface 614. Received program code may be executed by processor 607 as it is received, and/or stored in disk drive 610, or other non-volatile storage for later execution. In an embodiment, the computing system 600 operates in conjunction with a data storage system 631, e.g., a data storage system 631 that includes a database 632 that is readily accessible by the computing system 600. The computing system 600 communicates with the data storage system 631 through a data interface 633. A data interface 633, which is coupled with the bus 606, transmits and receives electrical, electromagnetic or optical signals that include data streams representing various types of signal information, e.g., instructions, messages and data. In embodiments of the invention, the functions of the data interface 633 may be performed by the communication interface 614.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

We claim:

1. A computer implemented method for implementing knowledge base-driven generation of immunoassay protocols and procedures, comprising:
identifying or determining, at an expert system or knowledge engineering base, one or more proteins of interest for one or more tumor types of interest or a disease group of interest; and
generating, at a protocol generation module stored at least partially in memory and including or functioning in tandem with one or more processors of a computing system, an immunoassay protocol based in part or in whole upon one or more immunoassay protocol rules and the one or more tumor types of interest or a disease group of interest.

2. The computer implemented method of claim 1, further comprising:
generating, at an immunoassay procedure generation module stored at least partially in the memory and including or functioning in tandem with the one or more processors of the computing system, an immunoassay procedure based in part or in whole upon one or more immunoassay experimental conditions.

3. The computer implemented method of claim 2, further comprising:
transmitting, via one or more network components or a removable storage device, the immunoassay procedure in a machine accessible format to automated staining equipment that performs an immunoassay according to the immunoassay procedure.

4. The computer implemented method of claim 1, further comprising:
calibrating or training one or more modules including the expert system or knowledge base or the protocol generation module at least by using results of detecting or measuring one or more proteins of interest for the one or more tumor types of interest or the disease group of interest as a test data set.

5. The computer implemented method of claim 1, further comprising:
identifying or determining one or more proteins of interest based in part or in whole upon the disease group of interest or the one or more tumor types of interest for a sample;
determining one or more primary antibodies based in part or in whole upon the one or more proteins of interest using one or more primary antibody rules; and
identifying or determining, at the expert system or the knowledge engineering base, one or more relative strength indices corresponding to the one or more primary antibodies.

6. The computer implemented method of claim 5, further comprising:
identifying a number of different species in the one or more primary antibodies;
identifying or determining a first species and a second species of the one or more primary antibodies; and
determining, at one or more rule modules, whether the first species and the second species are identical.

7. The computer implemented method of claim 6, further comprising:
activating a set of concurrent multiplex rules for one or more rule modules based in part or in whole upon a results of determining whether the first species and the second species are identical;
identifying two or more primary antibodies comprising a first primary antibody and a second primary antibody based in part or in whole upon one or more primary antibody rules and the set of concurrent multiplex rules; and
determining one or more enzymes or fluorescent probes that bind to the first primary antibody and the second primary antibody based in part or in whole upon one or more enzyme or fluorescent rules and the set of concurrent multiplex rules.

8. The computer implemented method of claim 7, further comprising:
determining a first secondary antibody and a second secondary antibody based in part or in whole upon the first primary antibody, the second primary antibody, one or more secondary antibody rules, and the set of concurrent multiplex rules; and
determining a first substrate or chromogen and a second substrate or chromogen based in part or in whole upon the first and second primary antibodies or the first and second secondary antibodies, one or more substrate or chromogen rules, and the set of concurrent multiplex rules.

9. The computer implemented method of claim 7, further comprising:
generating, at the protocol generation module, a concurrent multiplex immunoassay protocol for the immunoassay protocol by including information about at least the first primary antibody, the second primary antibody, and the one or more enzymes or fluorescent probes into the concurrent multiplex immunoassay protocol.

10. The computer implemented method of claim 5, further comprising:
identifying a number of different species in the one or more primary antibodies;
identifying or determining a species of the one or more primary antibodies; and
determining, at one or more rule modules, an enzyme or a fluorescent probe based in part or in whole upon the species and one or more enzyme or fluorescent probe rules.

11. The computer implemented method of claim 5, further comprising:
determining, at one or more rule modules, a secondary antibody that is used to bind to the one or more primary antibodies based in part or in whole upon one or more secondary antibody rules; and
determining, at the one or more rule modules, a substrate or a chromogen based in part or in whole upon detection of binding between the one or more primary antibodies and a protein of interest and one or more substrate or chromogen rules.

12. The computer implemented method of claim 10, further comprising:
generating, at the protocol generation module, the immunoassay protocol at least by adding at least the one or more primary antibodies, the enzyme or the fluorescent probe into the immunoassay protocol.

13. The computer implemented method of claim 12, further comprising:
updating, at the protocol generation module, the immunoassay protocol at least by adding the secondary antibody or the substrate into the immunoassay protocol.

14. The computer implemented method of claim 6, further comprising:
activating a set of sequential multiplex rules for one or more rule modules;
generating, at the protocol generation module, a sequential multiplex immunoassay protocol for the immunoassay protocol;
generating, at an immunoassay procedure generation module stored at least partially in the memory and including or functioning in tandem with the one or more processors of the computing system, a sequential immunoassay procedure based in part or in whole upon one or more sequential immunoassay experimental conditions.

15. A system for implementing knowledge base-driven generation of immunoassay protocols and procedures, comprising:
one or more modules, at least one of which is stored in part or in whole in memory and comprises at least one processor including one or more processor cores executing one or more threads in a computing system;
a non-transitory computer accessible storage medium storing thereupon program code that includes a sequence of instructions that, when executed by the at least one processor, causes the at least one processor at least to:
identify or determine, at an expert system or knowledge engineering base, one or more proteins of interest for one or more tumor types of interest or a disease group of interest; and
generate, at a protocol generation module stored at least partially in memory and including or functioning in tandem with one or more processors of a computing system, an immunoassay protocol based in part or in whole upon one or more immunoassay protocol rules and the one or more tumor types of interest or a disease group of interest.

16. The system of claim 15, wherein the program code includes the sequence of instructions that, when executed by the at least one processor, further cause the at least one processor to:
generate, at an immunoassay procedure generation module stored at least partially in the memory and including or functioning in tandem with the one or more processors of the computing system, an immunoassay procedure based in part or in whole upon one or more immunoassay experimental conditions.

17. The system of claim 15, wherein the program code includes the sequence of instructions that, when executed by the at least one processor, further cause the at least one processor to:
identify or determine one or more proteins of interest based in part or in whole upon the disease group of interest or the one or more tumor types of interest for a sample;
determine one or more primary antibodies based in part or in whole upon the one or more proteins of interest using one or more primary antibody rules; and
identify or determine, at the expert system or the knowledge engineering base, one or more relative strength indices corresponding to the one or more primary antibodies.

18. The system of claim 17, wherein the program code includes the sequence of instructions that, when executed by the at least one processor, further cause the at least one processor to:
identify a number of different species in the one or more primary antibodies;
identify or determine a first species and a second species of the one or more primary antibodies; and
determine, at one or more rule modules, whether the first species and the second species are identical.

19. The system of claim 18, wherein the program code includes the sequence of instructions that, when executed by the at least one processor, further cause the at least one processor to:
activate a set of concurrent multiplex rules for one or more rule modules based in part or in whole upon a results of determining whether the first species and the second species are identical;
identify two or more primary antibodies comprising a first primary antibody and a second primary antibody based in part or in whole upon one or more primary antibody rules and the set of concurrent multiplex rules; and
determine one or more enzymes or fluorescent probes that bind to the first primary antibody and the second primary antibody based in part or in whole upon one or more enzyme or fluorescent rules and the set of concurrent multiplex rules.

20. The system of claim 18, wherein the program code includes the sequence of instructions that, when executed by the at least one processor, further cause the at least one processor to:
generate, at the protocol generation module, a concurrent multiplex immunoassay protocol for the immunoassay protocol by including information about at least the first primary antibody, the second primary antibody, and the one or more enzymes or fluorescent probes into the concurrent multiplex immunoassay protocol.

21. The system of claim 18, wherein the program code includes the sequence of instructions that, when executed by the at least one processor, further cause the at least one processor to:
activate a set of sequential multiplex rules for one or more rule modules; and
generate, at the protocol generation module, a sequential multiplex immunoassay protocol for the immunoassay protocol.

22. An article of manufacture comprising a non-transitory computer accessible storage medium having stored thereupon a sequence of instructions which, when executed by at least one processor or at least one processor core executing one or more threads, causes the at least one processor or the at least one processor core to perform a set of acts for implementing knowledge base-driven generation of immunoassay protocols and procedures, the set of acts comprising:
identifying or determining, at an expert system or knowledge engineering base, one or more proteins of interest for one or more tumor types of interest or a disease group of interest; and
generating, at a protocol generation module stored at least partially in memory and including or functioning in tandem with one or more processors of a computing system, an immunoassay protocol based in part or in whole upon one or more immunoassay protocol rules and the one or more tumor types of interest or a disease group of interest.

23. The article of manufacture of claim 22, the set of acts further comprising:
generating, at an immunoassay procedure generation module stored at least partially in the memory and including or functioning in tandem with the one or more processors of the computing system, an immunoassay procedure based in part or in whole upon one or more immunoassay experimental conditions.

24. The article of manufacture of claim 22, the set of acts further comprising:
identifying or determining one or more proteins of interest based in part or in whole upon the disease group of interest or the one or more tumor types of interest for a sample;
determining one or more primary antibodies based in part or in whole upon the one or more proteins of interest using one or more primary antibody rules; and
identifying or determining, at the expert system or the knowledge engineering base, one or more relative strength indices corresponding to the one or more primary antibodies.

25. The article of manufacture of claim 24, the set of acts further comprising:
identifying a number of different species in the one or more primary antibodies;
identifying or determining a first species and a second species of the one or more primary antibodies; and
determining, at one or more rule modules, whether the first species and the second species are identical.

26. The article of manufacture of claim 25, the set of acts further comprising:
activating a set of concurrent multiplex rules for one or more rule modules based in part or in whole upon a results of determining whether the first species and the second species are identical;
identifying two or more primary antibodies comprising a first primary antibody and a second primary antibody based in part or in whole upon one or more primary antibody rules and the set of concurrent multiplex rules; and
determining one or more enzymes or fluorescent probes that bind to the first primary antibody and the second primary antibody based in part or in whole upon one or more enzyme or fluorescent rules and the set of concurrent multiplex rules.

27. The article of manufacture of claim 25, the set of acts further comprising:
generating, at the protocol generation module, a concurrent multiplex immunoassay protocol for the immunoassay protocol by including information about at least the first primary antibody, the second primary antibody, and the one or more enzymes or fluorescent probes into the concurrent multiplex immunoassay protocol.

28. The article of manufacture of claim 25, the set of acts further comprising:
activating a set of sequential multiplex rules for one or more rule modules; and
generating, at the protocol generation module, a sequential multiplex immunoassay protocol for the immunoassay protocol.
